(19) United States
(12) Patent Application Publication
(10) Pub. No.: US 2013/0095789 A1
(43) Pub. Date: Apr. 18, 2013

(54) ACCESS POINT

(71) Applicants: Peter Keevill, Bath (GB); Mark Walker, Wiltshire (GB); Cristavao Da Silva, Cambridge (GB); Andrea Giustina, Milan (IT); Michael Wege, Amsterdam (NL)

(72) Inventors: Peter Keevill, Bath (GB); Mark Walker, Wiltshire (GB); Cristavao Da Silva, Cambridge (GB); Andrea Giustina, Milan (IT); Michael Wege, Amsterdam (NL)

(73) Assignee: UBIQUISYS LIMITED, Wiltshire (GB)

(21) Appl. No.: 13/405,060

(22) Filed: Feb. 24, 2012

(30) Foreign Application Priority Data
Oct. 14, 2011 (GB) 1117783.9

(51) Int. Cl. H04W 88/00; H04W 36/00; H04W 84/12; H04W 12/00

(52) U.S. Cl. 455/411; 455/436

(57) ABSTRACT

Methods of operation of an access point are disclosed. These methods may involve authenticating a user equipment device in the access point. Access points configured for operating in accordance with the methods are also disclosed. Additionally, methods of operation of user equipment devices, and user equipment devices themselves configured for operating, in conjunction with the access points are disclosed. Still further, core network nodes configured to operate with the access points are disclosed.

### BACKGROUND

This invention relates to an access point, and in particular to an access point that can be used to establish connections with user equipment devices using both a cellular air interface and a WiFi air interface.

Many mobile devices are equipped with radio transceivers that allow them to connect to a network either using WiFi or using a cellular radio access technology, such as GPRS, WCDMA or LTE. Typically, the user will make use of the cellular radio access technology while moving, but might choose to use WiFi when stationary in the vicinity of a WiFi access point. In some situations, WiFi will provide higher data rates over the air interface, and thereby allow faster upload and download times. However, discovery of available WiFi access points typically involves selecting a suitable access point, and subsequent authentication typically requires the user to enter a password. Thus, the use of WiFi might be less efficient than that of the cellular access technology, even if the data rate over the air interface is higher.

### SUMMARY

According to aspects of the present invention, there are provided methods of operation of an access point. According to other aspects of the invention, there are provided access points configured for operating in accordance with the methods. According to still further aspects of the invention, there are provided methods of operation of user equipment devices, and user equipment devices themselves configured for operating, in conjunction with the access points. According to still further aspects of the invention, there are provided core network nodes configured to operate with the access points.

### BRIEF DESCRIPTION OF THE DRAWINGS

For a better understanding of the present invention, and to show how it may be put into effect, reference will now be made, by way of example, to the accompanying drawings, in which:

FIG. 1 is a schematic diagram of a part of a telecommunications network, showing an access point in accordance with an aspect of the present invention;

FIG. 2 is a schematic diagram of a part of a telecommunications network, showing multiple access points;

FIG. 3 illustrates an authentication procedure;

FIG. 4 illustrates a second authentication procedure;

FIG. 5 illustrates an authentication procedure in accordance with an aspect of the invention;

FIG. 6 illustrates a second authentication procedure in accordance with an aspect of the invention;

FIG. 7 illustrates a third authentication procedure in accordance with an aspect of the invention;

FIG. 8 shows a first network architecture;

FIG. 9 shows a second network architecture;

FIG. 10 illustrates a fourth authentication procedure in accordance with an aspect of the invention;

FIG. 11 illustrates a fifth authentication procedure in accordance with an aspect of the invention;

FIG. 12 illustrates a deployment of access points in accordance with the invention;

FIG. 13 illustrates a stage in the operation of the deployment of FIG. 12;

FIG. 14 illustrates a second stage in the operation of the deployment of FIG. 12;

FIG. 15 illustrates a third stage in the operation of the deployment of FIG. 12;

FIG. 16 illustrates a further authentication procedure in accordance with the invention;

FIG. 17 illustrates a part of a mobile communications network;

FIG. 18 illustrates a handover procedure in the network of FIG. 17;

FIG. 19 illustrates a second handover procedure in the network of FIG. 17;

FIG. 20 illustrates a third handover procedure in the network of FIG. 17;

FIG. 21 illustrates a fourth handover procedure in the network of FIG. 17;

FIG. 22 illustrates a part of a mobile communications network in accordance with an aspect of the invention;

FIG. 23 illustrates a handover procedure in the network of FIG. 22;

FIG. 24 illustrates a second handover procedure in the network of FIG. 22;

FIG. 25 illustrates a third handover procedure in the network of FIG. 22; and

FIG. 26 illustrates a fourth handover procedure in the network of FIG. 22.

### DETAILED DESCRIPTION

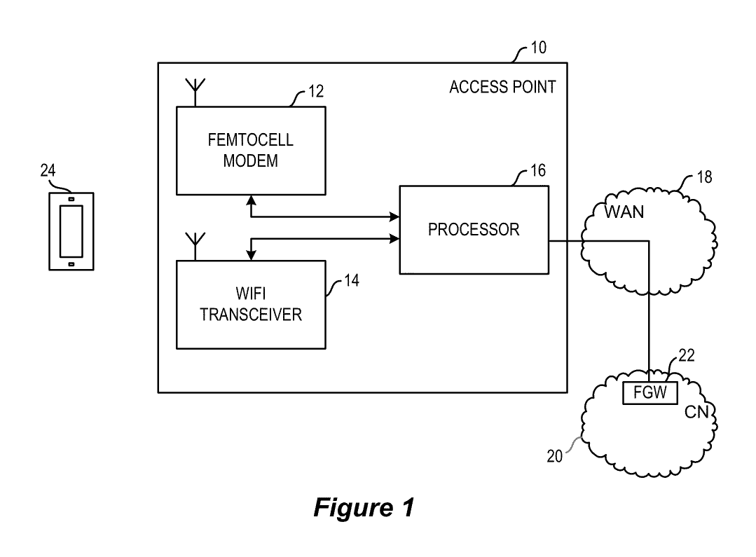

FIG. 1 shows a part of a telecommunication network, including a “small cell” access point 10. The access point 10 can for example be located in the premises of a customer of a cellular communications network, in which case it might be used to provide service to user equipment devices located within, or in the immediate vicinity of, the premises. The access point 10 includes both a 3G WCDMA femtocell modem 12 and a WiFi transceiver 14 (that is, a transceiver operating with a modulation technique as defined in one of the IEEE 802.11 standards) and a processor 16 which runs femtocell software and non-3GPP software such as caching, compression and WiFi functions. In other embodiments, the femtocell software and the other software functions are run on separate processors, with secure communication paths between the two software functions such that authentication information, user data and other high security information can be exchanged between the two software systems. Therefore a femtocell, forming part of a cellular network, and a WiFi access point are combined in a single unit. For example, the femtocell can be a 3G femtocell. In other embodiments, the femtocell can be a 4G LTE femtocell.

The access point 10 has a connection, for example using the customer's existing broadband internet connection, over a public wide area network (WAN) such as the internet 18. This allows the access point to be connected to the core network (CN) 20 of the cellular communications network through a femtocell gateway (FGW) 22. Equally, the processor 16 can direct traffic to other destinations over the internet, without passing it through the core network (CN) 20 of the cellular communications network, when required.

A user equipment (UE) device, such as a smartphone 24, is able to establish connections with the femtocell modem 12 over the 3G cellular air interface and/or with the WiFi transceiver 14 over the WiFi air interface using unlicensed radio spectrum.

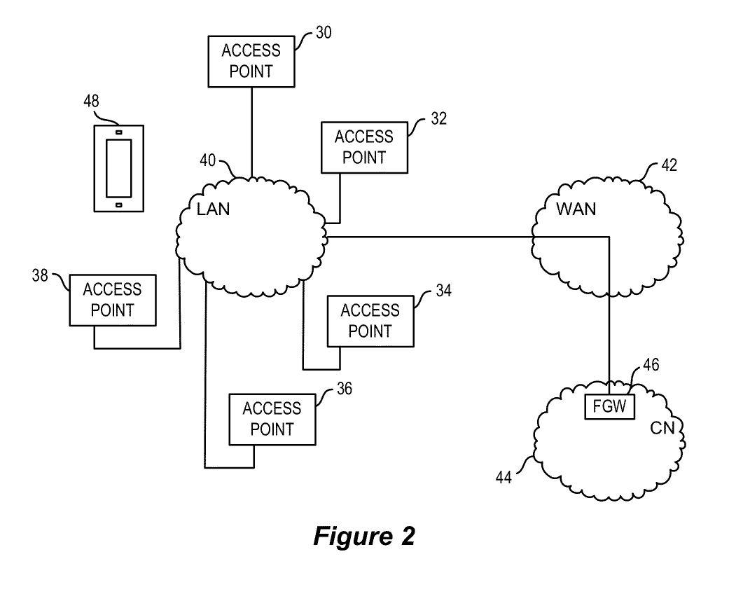

FIG. 2 shows a part of another telecommunications network, which in this case contains multiple “small cell” access points 30, 32, 34, 36, 38. Each of the access points 30, 32, 34, 36, 38 can have the same general form as the access point 10 shown in FIG. 1. The access points 30, 32, 34, 36, 38 can be used to provide coverage across a large building, such as an indoor shopping mall or large office building, or across an external area having some common management, such as a shopping centre, university campus, business park, or the like. Thus, the access points 30, 32, 34, 36, 38 are connected together, for example by means of a local are network (LAN) 40 as shown in FIG. 2. Five access points are shown, but it will be appreciated that any number of such access points can be deployed, depending upon the circumstances.

As described with reference to FIG. 1, each access point 30, 32, 34, 36, 38 has a connection over a public wide area network (WAN) such as the internet 42. This allows the access point to be connected to the core network (CN) 44 of the cellular communications network through a femtocell gateway (FGW) 46. Equally, traffic can be directed to other destinations over the internet, without passing it through the core network (CN) 44 of the cellular communications network, when required.

A user equipment (UE) device, such as a smartphone 48, is able to establish connections with any one of the access points 30, 32, 34, 36, 38 over the cellular air interface and/or over the WiFi air interface using unlicensed radio spectrum. In this illustrated example, the cellular air interface is a 3G air interface, and the remainder of the description will refer to this specific case, but the cellular air interface can rely on any cellular technology, including, but not limited to, a 4G LTE cellular technology.

The basic mode of operation of the access point is that 3G will be the “master” connection and WiFi the “slave” for any UE device that includes both 3G and WiFi radio transceivers. The co-location of WiFi and 3G in the access point allows localised and dynamic decision making on authentication and usage policy of the two air interfaces to offer an overall better user experience by making discovery and authentication of WiFi automatic from a user point of view and allowing the use of potentially higher WiFi air interface speeds to reduce upload/download times. The result is to make the WiFi experience more like cellular where discovery and authentication are, in almost all circumstances, zero-touch and invisible to the user.

The close integration of the 3G and WiFi solutions also allows the WiFi traffic to be connected into a 3G Iuh gateway which simplifies WiFi deployment by a cellular operator in that it is included within standard 3G infrastructure. No specialised WiFi core elements are required, providing economic advantages to the operator whilst also delivering high security for the WiFi traffic and attached WiFi users.

When considering the arrival, registration and subsequent operation of a 3G/WiFi UE, such as a smartphone, on a combined 3G/WiFi access point, there are a number of operational steps that can be controlled by 3G processes to allow the WiFi connection in the UE to attach and provide managed service.

### Discovery

The WiFi transceiver in the access point detects signals transmitted by other nearby WiFi access points, and uses the results to configure itself so that it operates on the least interfered WiFi frequency. Alternatively, the choice of WiFi channel can be configured in conjunction with the selection of UMTS Primary Scrambling Code (PSC), in order to maximise diversity and interference distance between access points.

The WiFi power setting can also be determined based on measurements made in the access point, in a manner corresponding to power setting in femtocells. In an environment as shown in FIG. 2, the configuration information of each access point can be shared with each other access point, for example over a local area network or a common IP connection, to assist in configuration.

The access point also uses the detected signals transmitted by other nearby WiFi access points to set a locally-determined identifier, for example a service set identifier (SSID). This self-configuration can be repeated as necessary to adapt to the changing RF environment as other WiFi access points come and go around the cell, but the SSID would preferably remain constant unless the same SSID were detected to be in use by another local access point, in which case it could be changed.

A first question is whether a UE, that has roamed onto the access point so that it has a connection thereto over the cellular air interface, should also establish a WiFi connection. This can be configured in the access point so that: all connected UEs are invited to connect to the WiFi access point; only compatible UEs are invited to connect to the WiFi access point; all UEs that are determined to be involved in sessions requiring high data rates are invited to connect to the WiFi access point; or only UEs that initiate a request are invited to connect.

In this way, the access policy of the femtocell can be extended to the co-located WiFi access point. Thus, if the femtocell is operating in closed mode, with a predetermined list of allowed users (a “white list”), the same list of users can be allowed to use the WiFi access point, if desired. Alternatively, the WiFi access point can be made open to guest users, in which case it is possible to reserve capacity for users on the white list, and to throttle the data rate for guest users when necessary, or even to redirect guest users when the needs of the white list users make this necessary.

In any event where a connection is to be established, the WiFi transceiver in the UE needs to be configured to attempt to connect to the WiFi access point included within the small cell, and therefore the locally determined SSID needs to be set up within the UE WiFi transceiver. There are a number of mechanisms that can be used to provide an appropriate communications path to perform this function.
In 3GPP Rel9 onwards, the OMA device manager (OMA-DM) within the phone can be provided with an ANDSF (Access Network Discovery and Selection Function) file that defines the available WiFi network SSID. Conventional use of OMA-DM/ANDSF is from a centralised server within the core network, but the present invention envisages the use of a mini-OMA-DM server providing a local ANDSF policy definition. OMA-DM uses a number of transport mechanisms, such as SMS.
A smartphone App, or smartphone operating system connection manager function, could also be created which receives SMS or other signalling from the 3G element within the small cell which defines the SSID. This is then automatically provided to the WiFi control function within the UE to allow the WiFi transceiver to connect to the small cell WiFi access point. It is notable that the SMS is originated locally within the small cell 3G femtocell access point (FAP).
A smartphone App, or smartphone operating system connection manager function, might also be able to extract specific information broadcast on the SIBs within the broadcast channel of the 3G FAP and use this data to configure the SSID. This may require an update to the UE software to allow this.
An SMS can be initiated from the small cell FAP which includes the SSID which the user can manually apply to the WiFi control function of the UE. Again, it is notable that this involves the use of a locally generated SMS.

### Authentication

With the UE having connected to the WiFi transceiver within the small cell, the next step is to authenticate with the WiFi access point. There are several methods whereby this can be achieved.

In general terms, the authentication procedure for the WiFi transceiver is unified with the authentication procedure for the cellular access point.

The current WLAN base standard, i.e., IEEE Std 802.11-2007 defines two forms of authentication: 1) Pre-Shared Key authentication and 2) IEEE 802.1X/EAP-based authentication.

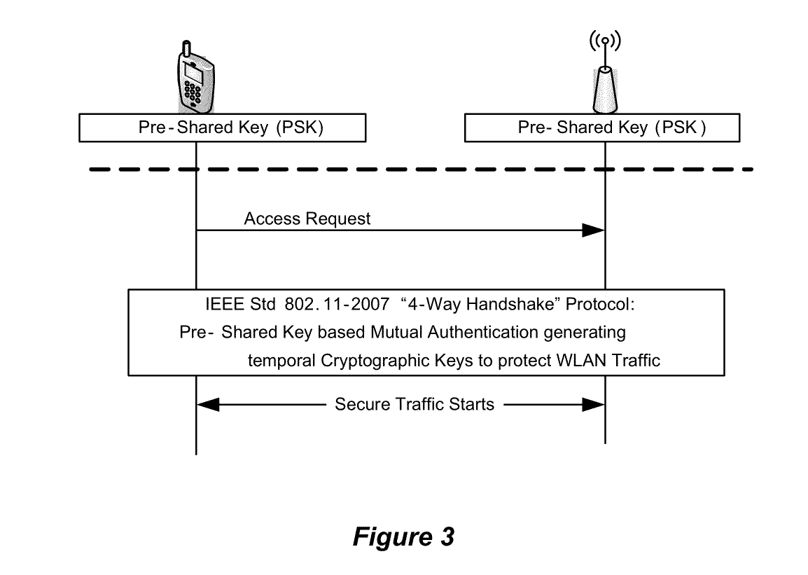

The Wi-Fi Alliance mandates that all WPA/WPA2 certified devices support at least Pre-Shared Key Authentication, however this form of authentication is usually associated with what is called WPA/WPA2-Personal mode; where there is a special ‘association’ between the WLAN Station and one specific WLAN Access Point (AP) [e.g. Residential or Small Office situations] because Pre-Shared Key authentication relies on a Shared Key/secret having been pre-configured in the Station and the AP before the Station tries to connect to the AP (FIG. 3).

This makes Pre-Shared Key Authentication by itself unsuitable to ‘roaming’ scenarios where clients continuously move between APs with which they had no previous association.

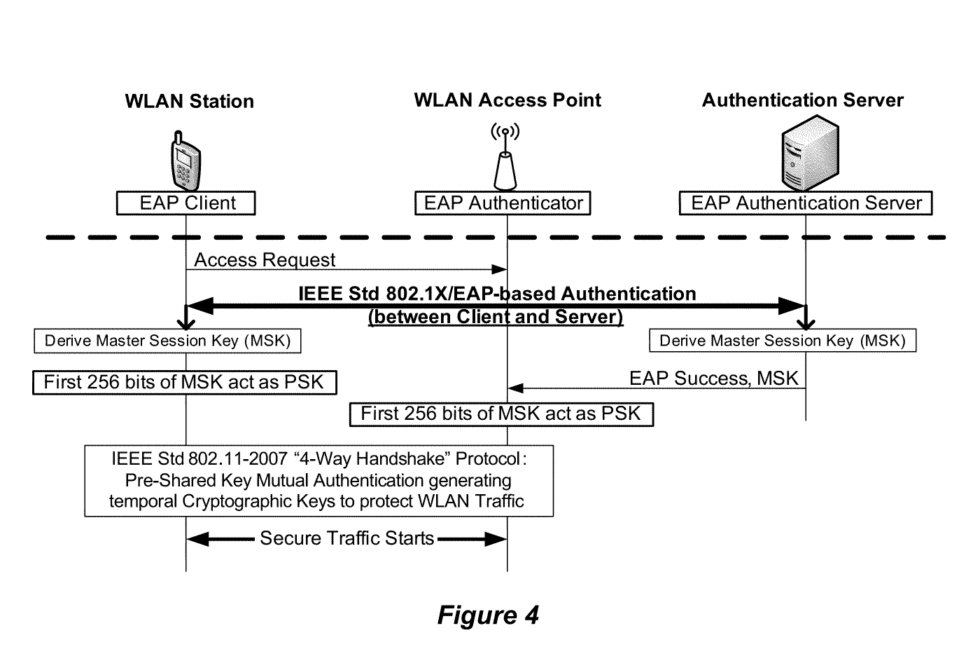

The IEEE 802.1X/EAP-based authentication (FIG. 4), which is typically used in what the Wi-Fi Alliance calls WPA/WPA2-Enterprise mode, solves this problem by introducing a third entity in the authentication framework, namely the (EAP) authentication server, which typically connects to multiple APs. In this framework, authentication first takes place between the WLAN Station (acting as EAP client) and the EAP Authentication Server—with the AP essentially acting in pass-through mode. If EAP authentication is successful the EAP client and the EAP Authentication Server will have derived (amongst other keying material) a fresh shared key called the Master Session Key (MSK) which the EAP Authentication Server pushes to the AP together with an indication of EAP authentication success. The MSK once installed in the WLAN Station and AP will act as a ‘one-time’ Pre-Shared Key for mutual authentication between the Station and the AP removing the need to pre-configure the WLAN Station and AP with that shared secret.

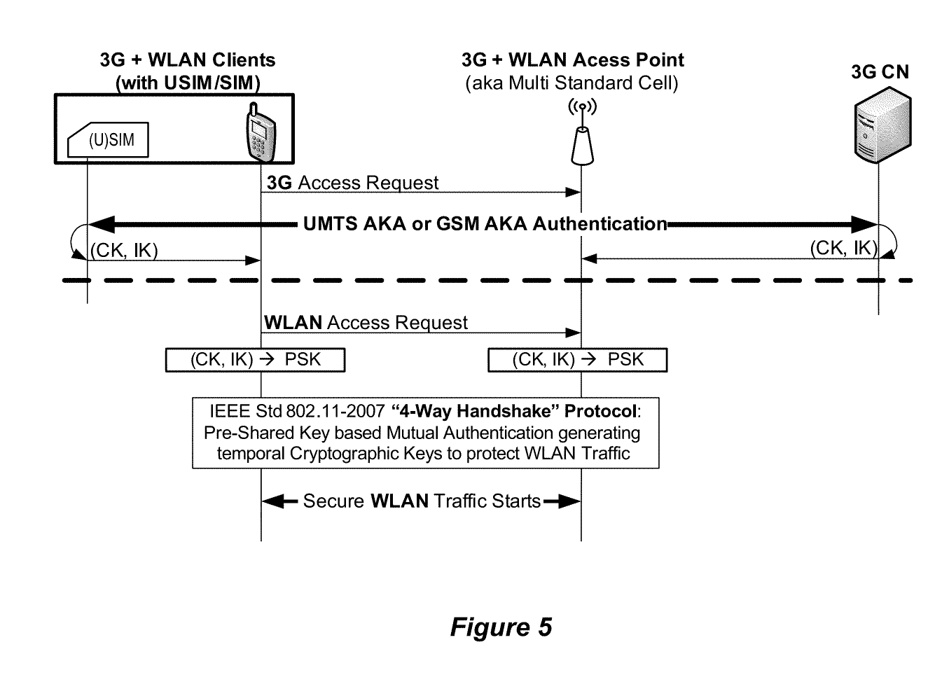

There is described here (FIG. 5) a solution by which a dual mode (3G+WLAN) UE equipped with a (U)SIM application (which or may not be located in a UICC smartcard) can interact with a dual mode 3G+WLAN Access point (aka Multi-Standard Cell) to use the 3GPP authentication (UMTS/GSM AKA) between the (U)SIM application and the 3G CN (via the 3G AP) to create fresh keying material in the 3G Client and 3G CN, which the 3G CN then pushes to the AP as per the usual RANAP Security Mode Control procedure over Iu/Iuh interface. This fresh keying material—once installed in the UE's WLAN Station and Multi-Standard Cell's WLAN AP—will act as a Pre-Shared Key which removes the need to pre-configure the WLAN Station and AP with that shared secret, much in the same way as in the IEEE 802.1X/EAP-based authentication case above.

Thus the method replaces the use of an IEEE 802.1X/EAP infrastructure with 3G infrastructure to deliver the same level of WLAN security for the WLAN part of the communications between a dual mode client and dual mode Access Point. This is of special relevance in the context of the deployment of Small Multi-Standard Cells, where the same Access Point supports at least 3G and WLAN air interfaces, since this will allow such an access point to be connected simply with the 3G CN for authentication purposes on both the WLAN and 3G air interfaces, saving the need to also integrate the AP in a IEEE 802.1X/EAP-based infrastructure.

Furthermore in the case of a deployment consisting of several networked Multi-Standard Cells a Pre-Shared Key generated during a UMTS/GSM AKA procedure over the 3G air interface in one cell can be forwarded by that cell to all other Multi-Standard Cells in the deployment; which means that the UE will automatically share the same PSK with all cells in the deployment, and as such can re-use the same PSK to securely associate to every cell in the deployment. This offers a clear advantage relative to the typical enterprise/metro WLAN mobility case where the WLAN Station must perform a whole new EAP authentication run each time it decides to securely associate with a new Access Point, which not only requires heavier usage of infrastructure resources but also increases the ‘handover’ delay.

There is therefore defined a combined 3G+WLAN authentication and key management (AKM) framework in which the IEEE standards-based Pre-Shared Key AKM defined for the WLAN air interface relies on a previous run of the 3GPP standards-based AKM over the 3G air interface to generate the Pre-Shared Key (which is at the root of the Pre-Shared Key AKM for the WLAN air interface)

This allows a dual mode client equipped with a (U)SIM application to securely access any dual mode access points working as per this invention over the WLAN air interface using IEEE-standards based Pre-Shared Key AKM without either having to previously configure Pre-Shared Key(s) in all those Access Points, which means that there is no need to deploy a parallel NW infrastructure to support IEEE 802.1X/EAP based authentication (in addition to its 3G counterpart) because the run of the 3GPP standards-based AKM over the 3G air interface replaces the run of IEEE 802.1X/EAP based authentication.

### Abbreviations

MM—the Mobility Management protocol as defined in 3GPP TS 24.008
GMM—the GPRS Mobility Management protocol as defined in 3GPP TS 24.008
RRC—the radio Resource Control protocol as defined in 3GPP TS 25.331
RANAP—the Radio Application NW Application Protocol as defined in 3GPP TS 25.413
RUA—the RANAP User Adaptation protocol as defined in 3GPP TS 25.468
HNBAP—the HNB Application Protocol as defined in 3GPP TS 25.469
EAP—the “Extensible Authentication Protocol defined in IETF RFC 3748
IEEE 802.11—the protocol defined in IEEE Std 802.11-2007

### 3GPP Abbreviations

### HNB—Home Node B

### CN—Core Network

Kc—GSM cipher key

### CK—UMTS Cipher Key

### IK—UMTS Integrity Key

Uu—Air interface between the UE and the UTRAN

### IEEE Std 802.1X and IEEE Std 802.11-2007 Abbreviations

### AP—Access Point

### AKM—Authentication and Key Management

WPA—Wireless Protected Access as defined by the Wi-Fi Alliance
WPA2—Wireless Protected Access 2 as defined by the Wi-Fi Alliance

### SSID—Service Set Identifier

### BSSID—Basic Service Set Identification (MAC Address of AP)

### PSK—Pre-Shared Key

### PMK—Pairwise Master Key

### MSK—Master Session Key

### STA_MAC@—MAC Address of the WLAN Station

STA_nonce—Nonce generated by the Station
AP_nonce—Nonce generated by the AP

### RSN IE—Robust Security Network Information Element

EAPOL—EAP over LAN protocol defined in IEEE Std 802.1X and IEEE Std 802.11-2007

### MIC—Message Integrity Code

### TKIP—Temporal Key Integrity Protocol

CCMP—Counter mode Cipher-block chaining Message authentication code Protocol

In order to provide a detailed description of the invention we shall first describe the how a WLAN Station securely associates with an Access Point in accordance with the current 802.11 base standard, i.e., IEEE Std 802.11-2007 which is at the base of the Wireless Protected Access frameworks WPA and WPA2 as defined by the Wi-Fi alliance.

We shall consider both Authentication and Key Management (AKM) frameworks and protocols supported by the standard, i.e., PSK-based and IEE 802.1X/EAP-based.

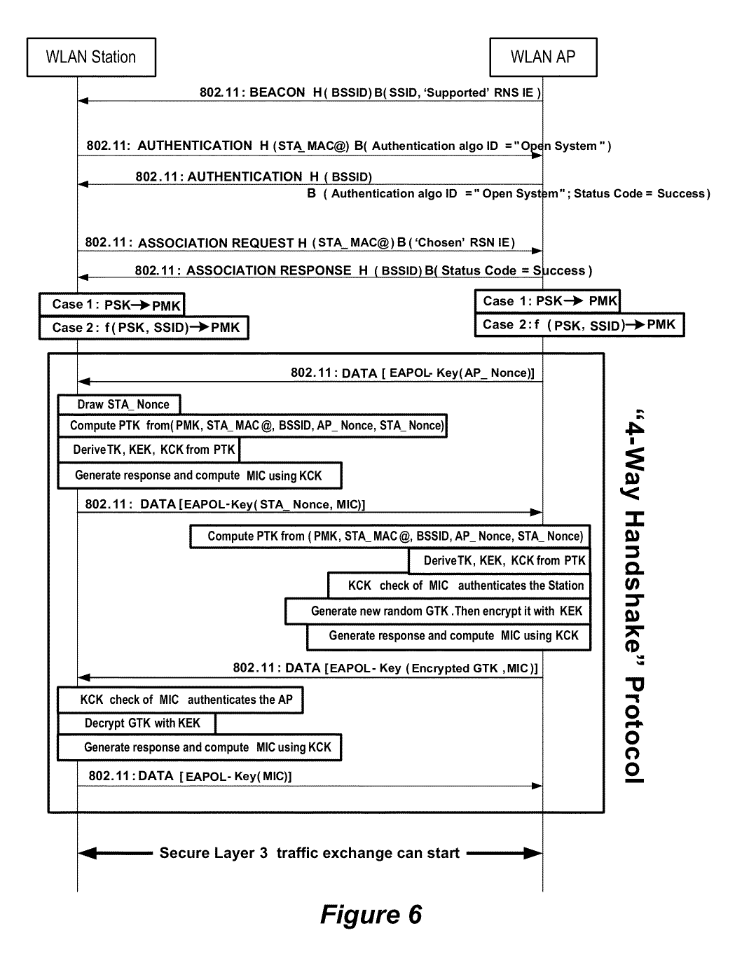

### PSK-Based AKM (FIG. 6):

In order to establish communication with an WLAN AP the WLAN Station determines the AP capabilities and requirements either from listening to the periodical IEEE 802.11: BEACON management frame broadcast by the AP (passive scanning) or by receiving a IEEE 802.11: PROBE RESPONSE management frame in response to a previously sent a IEEE 802.11: PROBE REQUEST management frame (active scanning). (In the Figure, H stands for Header of the IEEE 802.11 Management frame, B for body of the frame.)

In particular the Robust Security Network Information Element (RSN IE) sent by the AP (in BEACON and PROBE RESPONSE) will contain the AKM protocols [PSK and/or IEEE 802.1X] and the Cryptographic suite(s) [TKIP for WPA, CCMP for WPA2] supported by the AP.

If the WLAN Station then determines that it wishes to associate it will start by performing an open system authentication procedure in which it formally declares its MAC address as its identity via a IEEE 802.11: AUTHENTICATION management frame Note that the AP will not actually perform any type of authentication at this time (this procedure has only been left in the current standard to maintain backward compatibility with the pre-IEEE Std 802.11-2007 state machine) and so the AP will simply respond with a ‘Success’ Status-code.

Then the WLAN Station shall send an IEEE 802.11: ASSOCIATION REQUEST management frame to the AP which lists the capabilities supported by the WLAN Station and its choices from any supported options by the AP. In particular it will include a RSN IE with its chosen AKM protocol (in this case PSK-based) and Cryptographic suite. If the AP agrees with this choice it will reply with IEEE 802.11: ASSOCIATION RESPONSE management frame containing a ‘Success’ Status-code. This completes the negotiation of the security mechanisms to be used to establish the necessary security associations between the Station and AP for mutual authentication and the secure exchange of L3 traffic

The AP will then start the ‘4-Way Handshake’ key management protocol where at the top of the key hierarchy for the protection of unicast (aka pairwise) traffic resides what is called the Pairwise Master Key (PMK). This key is 256 bit long.

In the base standard, i.e., IEEE Std 802.11-2007, the PMK is simply the Pre-Shared Key (PSK), expected to be pre-configured directly into the AP and WLAN Station via some type of user interface. (Case 1 in FIG. 6).

However, when the Wi-Fi Alliance defined the requirements for WPA/WPA2 certification it introduced an extra level of security to protect the PSK against the fact that: 1) Many users configure very weak PSKs on their personal networks and 2) Most users do not change the PSK very often—if at all. This leaves the PSK somewhat vulnerable to attacks. In order to guard against this vulnerability the Wi-Fi Alliance added the requirement that (in both WLAN station and AP) the user-entered ‘password’ is combined with the AP's SSID and subject to cryptographic hashes in order to create a stronger PSK which is then used as the PMK. (Case 2 in FIG. 6).

Note: Several additional methods to generate secure PSKs without requiring non technology savvy users to manually configure strong passwords and to know/understand the concept of SSID, have been introduced under the optional Wi-Fi Protected Setup (WPS) framework by the Wi-Fi Alliance in 2007.

In any case, a 256 bit shared PMK key will be obtained and as per IEEE Std 802.11-2007 the AP starts the ‘4-Way Handshake’ protocol by sending a EAPOL-Key packet which amongst other information carries a randomly generated nonce. When the WLAN Station receives this packet it draws its own random nonce and then proceeds to compute the Pairwise Temporal Key (PTK) from the PMK, the Station's MAC address, the AP BSSID (i.e. its MAC address) and the AP and Station nonces using a Pseudo random function The Station then breaks the PTK into:
A Temporal Key (TK) to be used as the cryptographic key to protect the normal unicast L3 traffic
The EAPOL-Key KCK and KEK keys which will be used respectively to integrity protect and encrypt the subsequent EAPOL-Key packets

The Station then generates the response EAPOL-Key packet containing its nonce and protects the packet with a Message Integrity code (MIC) using the newly generated EAPOL-Key KCK key. which will act as proof that it knows EAPOL-Key KCK (which can only be the case because it knew PMK/PSK)

When the AP receives this packet it has the necessary information to perform the same key derivation operations as the Station and go from the PMK to the PTK and then TK, EAPOL-Key KEK and EAPOL-Key KCK. It will then use the newly derived EAPOL-Key KCK to verify the MIC in the received EAP-Key packet. If the MIC checks out the AP considers that the Station has been authenticated. It will then generate a new random Group Temporal Key (GTK) [which will protect the multicast/broadcast traffic sent by the AP], encrypt it with the EAPOL-Key KEK key, build a EAPOL-Key packet to carry it and finally protect the packet with a MIC computed using the newly generated EAPOL-Key KCK key

When the Station receives this packet it will use its EAPOL-Key KCK key to check the validity of the MIC. If the MIC checks out the Station considers that the AP has been authenticated. It will then use its EAPOL-Key KEK key to decrypt the GTK encapsulated in the packet. Finally it sends a EAPOL-Key packet which serves to inform the AP that mutual authentication has been successful and the new temporal keys (TK, KEK, KCK, GTK) have been installed.

Thus at the end of the ‘4-Way Handshake’ the Station and AP will have been mutually authenticated and installed the security associations to be used to protect unicast and multicast/broadcast traffic.

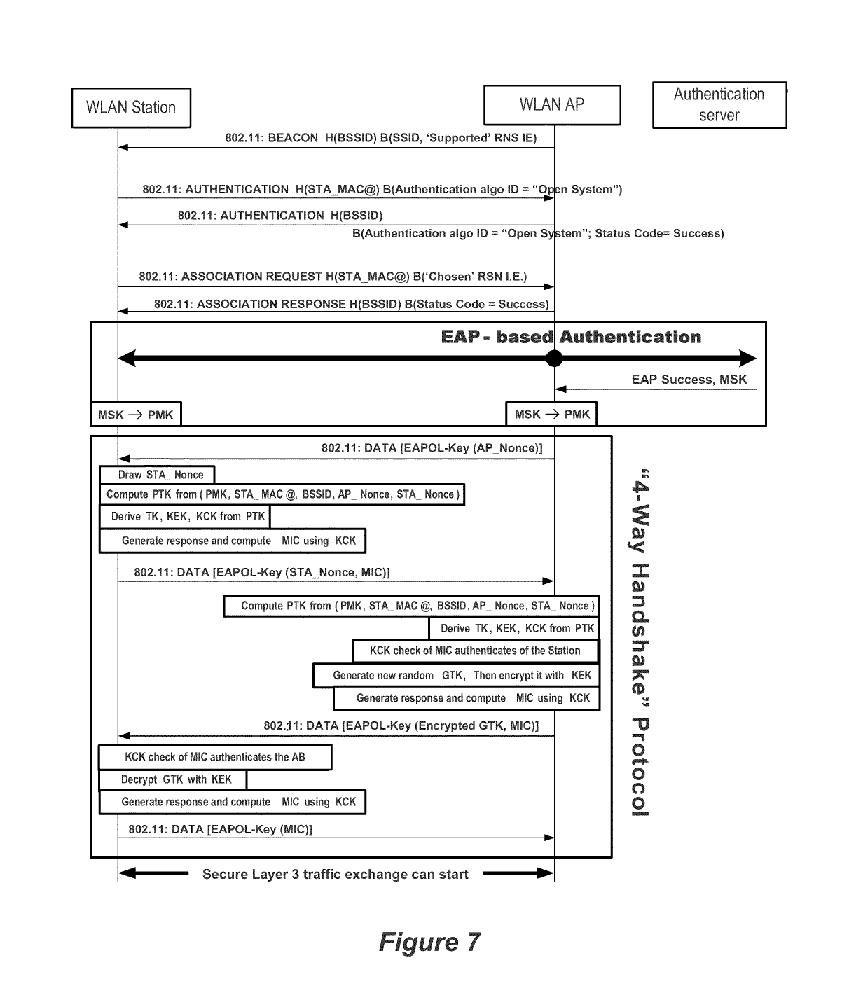

### IEEE 802.1X/EAP-based AKM (FIG. 7):

The ‘only’ difference between this case and the ‘PSK case’ is that after the Station informs the AP that it wishes to use IEEE 802.1X/EAP-based AKM (via the RSN IE it sends in the IEEE 802.11: AUTHENTICATION frame) the AP starts the EAP authentication procedure and only perform the ‘4-way handshake’ after the EAP run has been successfully completed. The EAP authentication procedure mutually authenticates the Station and the Authentication Server and generates (in the Station and Authentication Server) a shared key (the Master Session Key—MSK)—which the Authentication Server pushes to the AP—whose first 256 bits become the PMK. This PMK is then used in the subsequent ‘4-Way handshake’ protocol exchange to mutually authenticate the Station and the AP and install the newly derived temporal keys to protect the unicast and multicast/broadcast traffic.

Thus it can be seen that effectively what the EAP authentication run does is to install a per ‘WLAN station-AP association’ Pre-Shared Key (PSK) in the WLAN Station and the AP, which is then used as PMK during the 4-way Handshake which is the actual procedure that mutually authenticates the WLAN Station and AP.

The same can be achieved by performing a UMTS AKA/GSM AKA run between a USIM/SIM application in a dual mode (3G+WLAN) UE and the HLR/HSS in the 3G CN via a dual mode (3G+WLAN) Multi Standard Cell since this run results in fresh shared keying material being installed in both the UE and the Multi Standard Cell.

Two scenarios will be considered:
Stand-alone Multi Standard Cell
Deployment of networked Multi Standard Cells

### Scenario 1: Stand-alone Multi Standard Cell

In this scenario we consider a Multi Standard Cell which is not networked with other Multi Standard Cells.

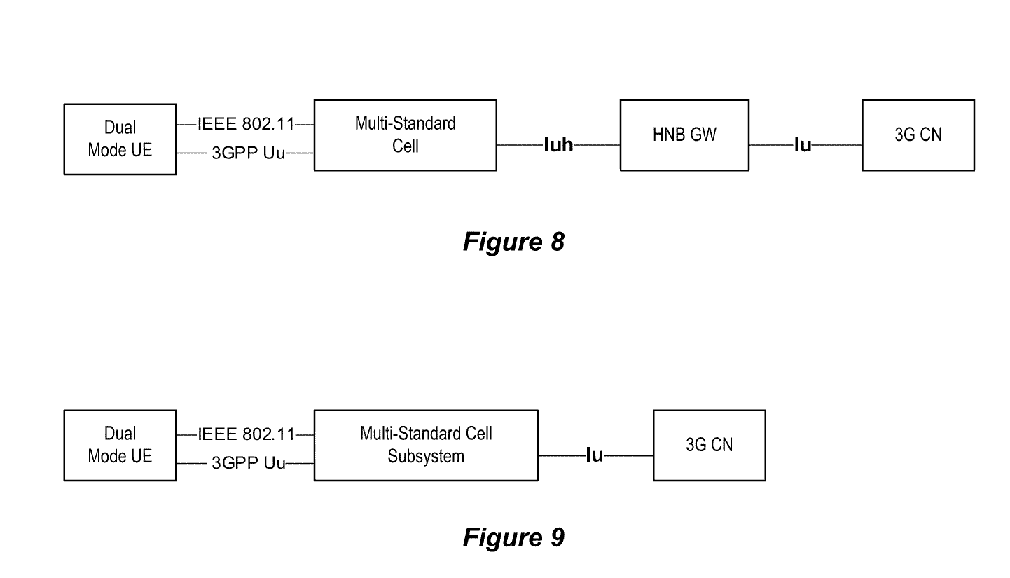

For concreteness we shall consider the most likely deployment scenario (FIG. 8) in which the 3G cell of the Multi Standard Cell is integrated into the 3G CN via a 3G HNB GW as if it was a 3G HNB, as defined in 3GPP TS 25.467, i.e., the Multi-Standard Cell (which supports both the IEEE 802.11 air interface and the 3GPP Uu air interface) exposes an Iuh interface to the HNB GW which in turn exposes a Iu interface to the 3G CN.

Note however that this invention applies to any Subsystem that is connected to the 3G CN via a standard Iu interface while exposing both a 3G and WLAN air interface, for example as shown in FIG. 9.

The dual mode UE will either contain a USIM application if the subscriber (identified by its IMSI) is a UMTS subscriber or a SIM application if the if the subscriber (identified by its IMSI) is a GSM subscriber. This application may or may not be located in a UICC (Universal Integrated Circuit Card).

### Case A: The Dual Mode UE has a UMTS Subscription in the HSS/HLR and Contains a USIM Application

The 3G ‘personality’ of the Multi Standard Cell will be broadcasting a locally unique LAI and RAI to force any UE that selects the cell to perform a location update (if the 3G client is MM Registered) and/or routeing area update (if the 3G client is GMM registered) as per 3GPP TS 24.008.

In both procedures the 3G CN will trigger a run of UMTS AKA before it accepts the Location Update or Routeing Area Update request. If successful this run of UMTS AKA will generate a fresh ciphering key (CK) and integrity protection key (IK) in the USIM application and in the 3G CN. These will be then pushed respectively to the 3G client of the UE and the Multi Standard Cell which can then use them to generate a Pre-Shared Key for subsequent WLAN authentication, i.e., PSK=f (CK, IK)

The function f that is used to generate the 256 bit PSK/PMK from CK and IK is up to implementation, however in order to protect CK and IK it should be a ‘one way function’, i.e. f(CK, IK) is such that (CK, IK) cannot be extracted from f(CK, IK).

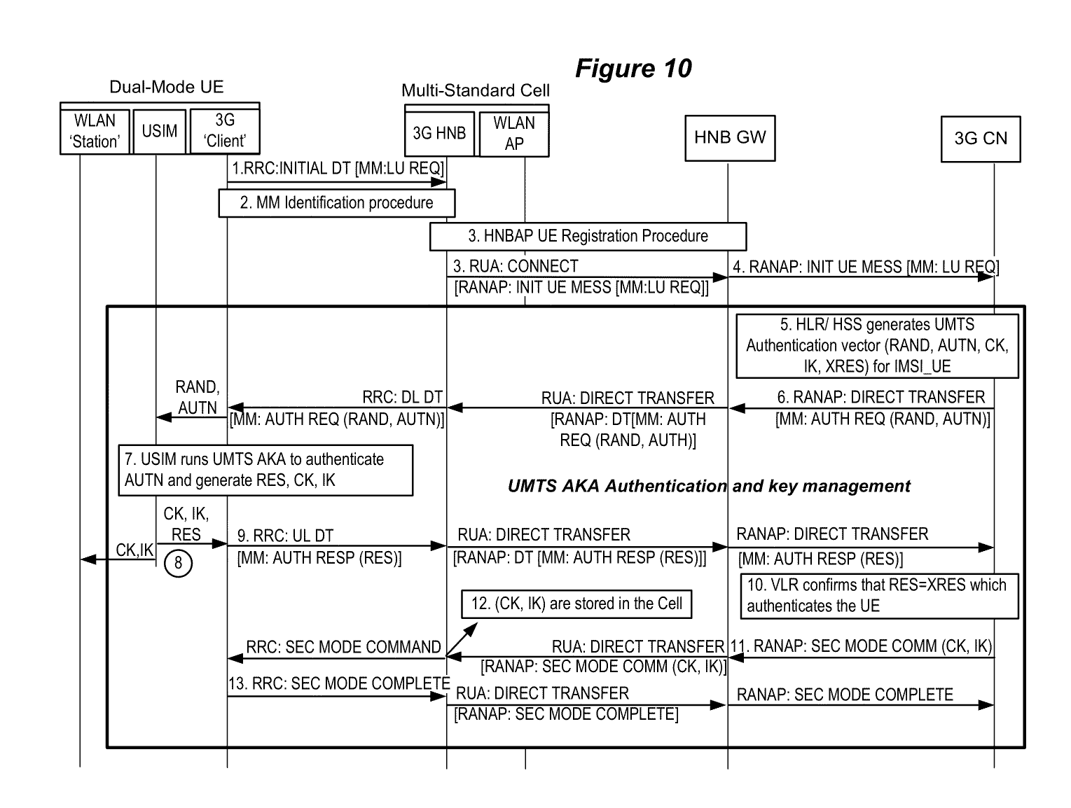

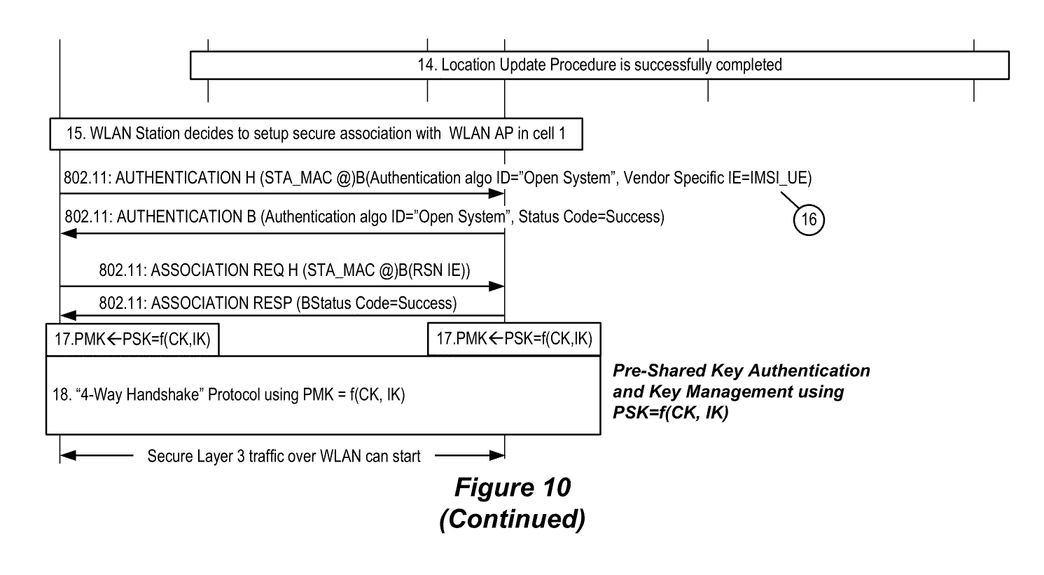

FIG. 10 shows the case where the UMTS AKA authentication that takes place during the CS domain location update is used to generate the Pre-Shared Key. If the UMTS AKA authentication that takes place during the PS location update was used the procedure would be very similar.

The following describes the main events in FIG. 10:
1) The UE camps on the cell and detects that the LAI has changed triggering a Location Update procedure
2) The Multi Standard Cell will trigger the MM identification procedure to obtain the UE's IMSI if this is not known
3) The Multi Standard Cell will then act as HNB and register the UE in the HNB

GW. If the HNB GW accepts the registration the Multi Standard Cell will forward the MM:LOCATION UPDATE REQ message (sent by the UE) to the HNB GW encapsulated in a RANAP: INITIAL UE MESSAGE message which is in turn encapsulated in a RUA: CONNECT message
4) The HNB GW forwards RANAP: INITIAL UE MESSAGE message to the 3G CN
5) This triggers the 3G CN to perform a UMTS AKA procedure to authenticate the UE: The HLR/HSS generates an UMTS authentication vector (RAND, AUTN, XRES, CK, IK) and send it to the MSC/VLR
6) The MSC/VLR will then generate the authentication challenge in the form of the MM: AUTHENTICATION REQUEST message carrying the AUTN and the RAND and sends to the UE via the HNB GW
7) When the message eventually arrives at the UE the USIM application will run UMTS AKA for the RAND to authenticate the AUTN and if this is successful generate CK, IK and RES
8) The USIM application provides (CK, IK, RES) to the UE's 3G client and the (CK, IK) to the UE's WLAN Station
9) The UE 3G client sends the response to the authentication challenge in the form of the MM: AUTHENTICATION RESPONSE message carrying the RES
10) When the message eventually arrives at the MSC/VLR this checks that XRES=RES to authenticate the UE
11) It will then trigger the security mode control procedure to instruct the Multi Standard Cell to start integrity protection and ciphering of the 3G air interface using IK and CK respectively
12) When the Multi Standard Cell receives this message it will store the CK and IK for this UE (IMSI) and perform the RRC Security Mode Control procedure to instruct the UE to start integrity protection and ciphering of the 3G air interface using IK and CK.
13) UE accepts the instruction and starts start integrity protection and ciphering of the 3G air interface
14) The Location Update procedure is successful completed
15) After this point the UE's WLAN Station may at any time request the setup of a secure association with the WLAN Access Point in the Multi Standard Cell according to the security options supported by the Multi Standard Cell as announced in the RSN IE of the BEACON frame. In this case the BEACON will announce that the only AKM (authentication and Key Management) suite supported is the PSK-based suite.
16) If the Multi Standard Cell is not operating in closed access mode the WLAN Station of the UE must provide the UE's IMSI to the WLAN AP, in a Vendor-specific IE in either the AUTHENTICATION or ASSOCIATION REQUEST management frames so that the Multi Standard Cell is able to know which (CK, IK) pair to use for the generation of PSK. See note 2 below
17) The WLAN Station will then use the CK and IK generated by the USIM application to generate a 256 bit PSK which will be used as the PMK. The WLAN Access Point in the Multi Standard Cell will perform the same operation on the CK and IK and thus obtain the same PSK/PMK
18) The UE's WLAN Station and the Multi Standard Cell WLAN AP perform the ‘4-way handshake’ protocol using the PSK as the PMK, which mutually authenticates them and generates the temporal keying material to protect the WLAN data traffic
   Note 1: The UMTS AKA procedure is described in detail in 3GPP TS 33.102
   Note 2: It is important that the Multi Standard Cell ‘knows’ which (CK, IK) to use for a WLAN Station requesting secure association. In the case of a Multi Standard Cell operating in ‘closed’ mode, i.e. providing service only to a pre-defined set of UEs the binding between each UE's WLAN identity (i.e. its MAC address) and 3GPP identity (IMSI) can simply be pre-provisioned in the Multi Standard Cell. In case the Multi Standard Cell is configured to operate in ‘open’ mode then the WLAN Station must provide the UE's IMSI in one of the ‘Vendor Specific’ Information Elements that are defined for the IEEE 802.11 AUTHENTICATION or ASSOCIATION REQUEST management frames. The Multi Standard Cell can then retrieve the correct (CK, IK).

### Case B: The Dual Mode UE has a GSM Subscription in the HSS/HLR and Contains a SIM Application

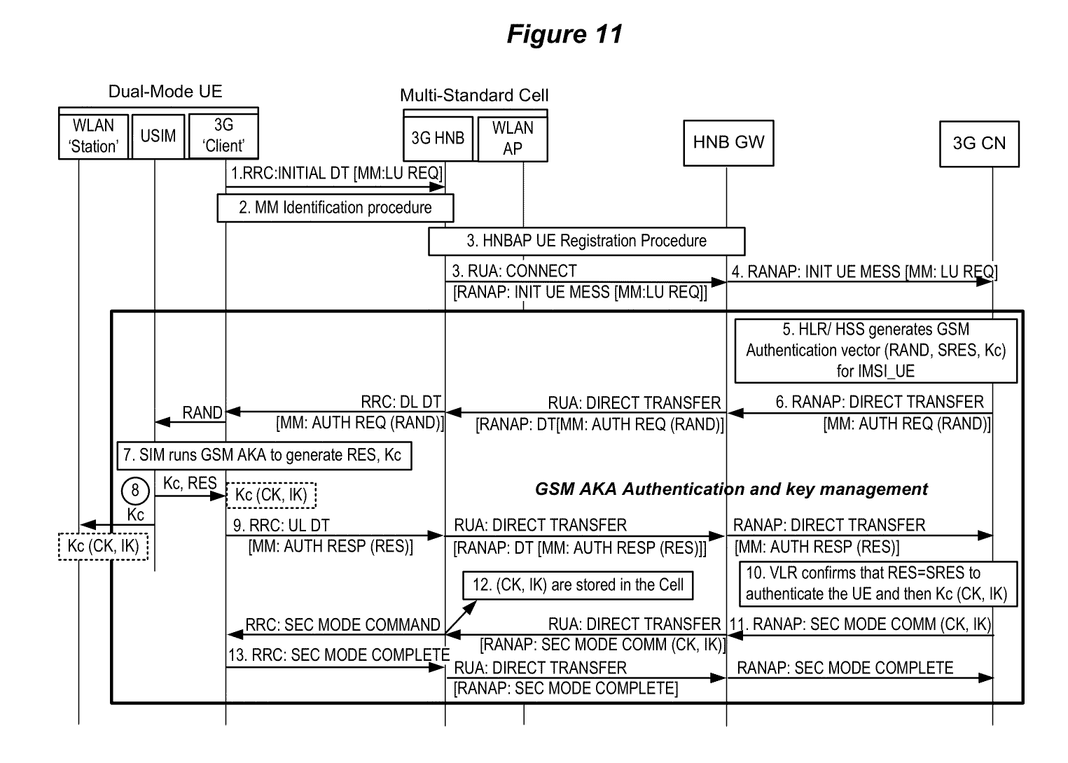

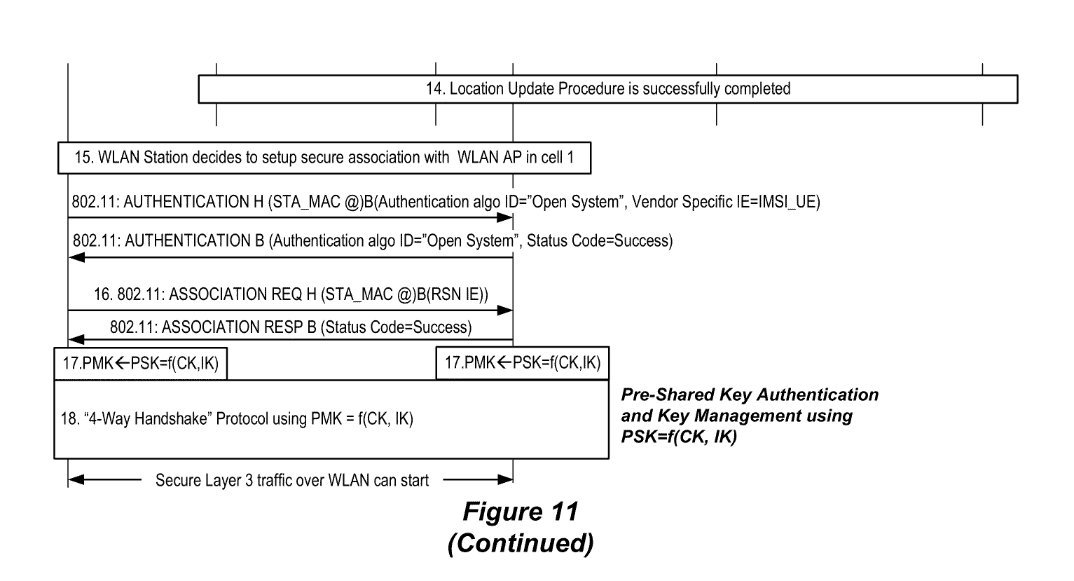

This is illustrated in FIG. 11. This case is basically the same as the previous case A, illustrated in FIG. 10, with the exception that the 3G CN triggers GSM AKA over the 3G air interface instead of UMTS AKA because here the UE has a GSM subscription in the 3G CN and not a UMTS subscription

As a result the following steps will differ:
5. This triggers the 3G CN to perform a GSM AKA procedure to authenticate the UE which starts by the HLR/HSS generating an authentication vector (RAND, SRES, Kc) and send it to the MSC/VLR
6. The MSC/VLR will then generate the authentication challenge in the form of the MM: AUTHENTICATION REQUEST message carrying the RAND
7. When the message eventually arrives at the UE the SIM application will run GSM AKA for the RAND and generate Kc and RES. Kc will act as the shared secret for PSK-based authentication on the WLAN interface between the UE's WLAN Station and the cell's WLAN Access Point. This can either be done using Kc itself to generate the 256 bit PSK or by first expanding Kc into a (CK, IK) pair and then generate the 256 bit PSK. (Note: The UE's 3G client will always expand Kc into (CK, IK) for the protection of the 3G air interface as per 3GPP TS 33.102). For ease of explanation reasons we shall assume here that Kc is first expanded into a (CK, IK), see below
8. The SIM application provides (Kc, RES) to the UE's 3G client and the (Kc) to the UE's WLAN Station. The UE's 3G client will derive the (CK, IK) keys from the Kc as defined in 3GPP TS 33.102. The UE's WLAN Station will do the same
9. The UE 3G client sends the response to the authentication challenge in the form of the MM: AUTHENTICATION RESPONSE message carrying the RES
10. When the message eventually arrives at the MSC/VLR this checks that SRES=RES to authenticate the UE
11. It will then expand Kc into (CK, IK) as per 3GPP TS 33.102 and trigger the security mode control procedure to instruct the Multi Standard Cell to start integrity protection and ciphering of the 3G air interface using IK and CK respectively
12. When the Multi Standard Cell receives this message it will store the CK and IK for this UE (IMSI) and perform the RRC Security Mode Control procedure to instruct the UE to start integrity protection and ciphering of the 3G air interface using IK and CK respectively
   . . .
17. The WLAN Station will then use the CK and IK generated by the USIM application to generate a 256 bit PSK which will be used as the PMK. The WLAN Access Point in the Multi Standard Cell will perform the same operation on the CK and IK and thus obtain the same PSK/PMK
   Note 1: The GSM AKA procedure is described in detail in 3GPP TS 33.102

### Scenario 2: Deployment of Networked Multi Standard Cells

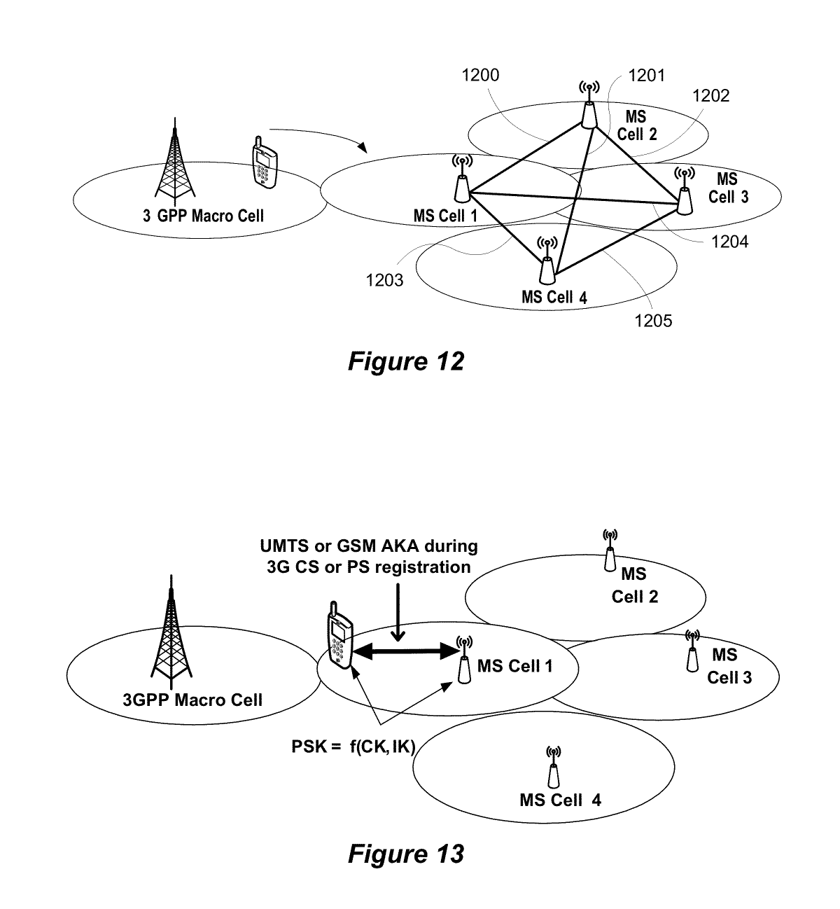

Networked Multi Standard Cells are a set of Multi Standard Cells which are in logical communication, either directly (as shown by the lines 1200, 1201, 1202, 1203, 1204, 1205 in FIG. 12) or through a local area network as shown in FIG. 2, or via a GW providing inter cell routing. The protocols used to interconnect the cells will be implementation dependent.

When the UE detects that it has entered the coverage area of one of these Multi Standard Cells it will perform a MM or GMM registration procedure that will trigger the 3G CN to perform a run of UMTS/GSM AKA (according to whether the subscriber is a UMTS or GSM subscriber). In the typical case that these cells will be operating a common LAI/RAI different from that of surrounding macro cells, then the change of LAI/RAI by itself will automatically trigger such procedures (MM Location Update/GMM Routeing Area Update). Each AKA run will end up with a shared (CK, IK) pair in the UE and the Multi Standard Cell.

If the Multi Standard Cell is unaware of a PSK for that UE (IMSI) (i.e. it was not informed by other Multi Standard Cells of one existing) it will generate one from the first generated (CK, IK)−PSK=f (CK, IK)

The UE will do the same and generate the same PSK (FIG. 13). How the UE will know when to generate a new PSK is implementation dependent. One example would be for all cells in a deployment to broadcast the same SSID, and for the UE to track whether or not it already had a PSK for that SSID. If not then the UE will use the first (CK, IK) generated under a cell using that SSID.

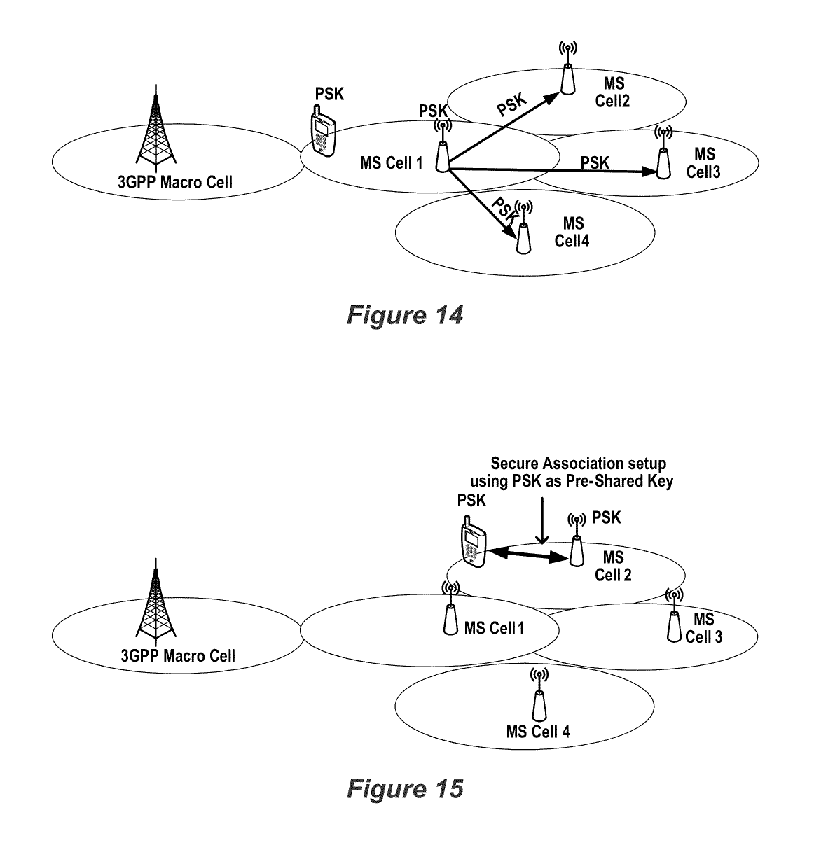

After a Multi Standard Cell generates a Pre-Shared Key for a UE (IMSI) it will immediately ‘broadcast’ the Pre-Shared Key to all other cells in the deployment (FIG. 14).

As a consequence the UE WLAN Station can now perform PSK-based authentication with any cell in the deployment using the same PSK (FIG. 15).

Note that this provides a clear advantage relative to the case where IEEE 802.1X/EAP authentication is used since in that case the UE WLAN Station would have to perform a new EAP round every time it associated with a new access point.

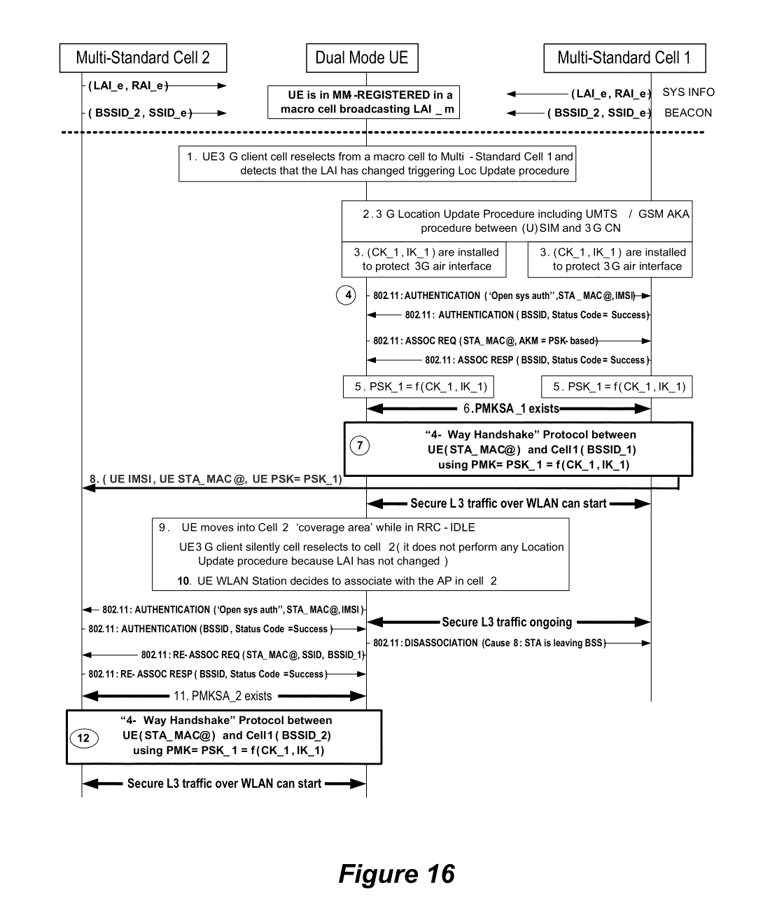

FIG. 16 shows one particular use case of the invention, for example in a metro-like networked Multi-Standard Cell deployment. These cells will be broadcasting (in their 3G System Information) a common LAI and RAI distinct from that of the macro NW. In addition they will be broadcasting an enterprise specific SSID in their IEEE 802.11: BEACON frames.
1. When a dual mode UE that is attached for 3GPP CS services in the macro NW enters the metro coverage area in idle mode the UE 3G client cell reselects to Multi-Standard Cell 1 and note that the Location Area has changed triggering the UE 3G client to perform a Location Updating Procedure.
2. During the Location Update procedure the 3G CN will trigger either a UMTS AKA procedure (if the subscriber is a UMTS subscriber) or a GSM AKA (if the subscriber is a GSM subscriber) which generates CK_{—}1 and IK_{—}1 in the UE and the 3G CN
3. The 3G CN will then perform a RANAP Security Mode Control procedure which will lead to the UE 3G client and the cell to install the just generated CK_{—}1 and IK_{—}1 keys to perform ciphering and integrity protection of the 3G air interface

4. At some point the UE WLAN Station will read the BEACON frame from the WLAN AP in cell 1 and learn its SSID which triggers it to try to securely associate with that AP. It will perform the usual IEEE 802.11 ‘open system’ Authentication and Association procedures during which it will convey to the AP the is of the UE it is part of via a Vendor-specific IE
5. The UE's IMSI allows the Cell to determine that the PSK for that WLAN Station should be derived from (CK_{—}1, IK_{—}1). Similarly the WLAN station in the UE also computes the PSK from (CK_{—}1, IK_{—}1)
6. At this time there is a PMKSA (Pairwise Master Key Security Association) in both the UE and the cell whose state includes the PMK (which is set to PSK_{—}1), the AKM protocol (PSK-based), and the AP MAC address (BSSID_{—}1)
7. From the PMKSA the AP function in Cell 1 can start the ‘4-Way Handshake’ protocol using the PMK to generate the temporal keying material to protect the L3 traffic during which the UE and the AP mutually authenticate by showing that they both know PMK (PSK_{—}1) after which secure WLAN traffic starts to be exchanged
8. If the ‘4-Way Handshake’ procedure is successful cell 1 will inform all other cells in the deployment of the following binding (IMSI of the UE, MAC address of the UE, PSK for the UE-PSK_{—}1)
9. At some later time the UE moves away from cell 1 and comes under the coverage of cell 2 triggering the UE 3G Client to perform cell reselection to cell 2 while still in RRC-IDLE mode. Since the LAI has not changed the UE will not perform any signalling to cell 2, however its WLAN Station will determine that it is best to associate with the AP in cell 2.

10. From reading the BEACON of cell 2 it knows cell 2 is part of the same NW since it is operating the same SSID as cell 1, the WLAN Station will thus automatically decide to re-use PSK_{—}1 to perform the PSK-based authentication with the AP function in Cell 2. The UE will include both its MAC address and IMSI in either the AUTHENTICATION (in the figure) of REASSOCATION REQ frames. This ensures that cell 2 can retrieve the (CK, IK) associated to the UE, i.e., (CK_{—}1, IK_{—}1) and check that the binding between UE's IMSI and MAC address corresponds to that informed by cell 1 (this makes it impossible for a rogue UE to modify its asserted MAC address). At the same time the UE should inform the AP function in Cell 1 that it is disassociating so that no more traffic for the UE is sent there
11. At this point both the UE and cell 2 have the necessary information to have a PMKSA, PMKSA_{—}2, whose state includes the PMK (which is again set to PSK_{—}1), the AKM protocol (PSK-based), and the Cell 2 MAC address (BSSID_{—}2)
12. From this PMKSA the AP function in Cell 2 can start the ‘4-Way Handshake’ protocol using the PMK to generate the temporal keying material to protect the L3 traffic during which the UE and cell 2 mutually authenticate by showing that they both know PMK (PSK_{—}1) after which the UE can restart its secure WLAN traffic now via cell 2

Thus, this arrangement has the advantage that the operator does not have to support the CAPEX and OPEX of a typical WLAN metro/enterprise infrastructure in order to provide WLAN services to 3G+WLAN UEs. Instead it can re-use its 3G infrastructure to support both the 3G and WLAN services.

Also, WLAN Mobility between networked WLAN access points that are part of Multi Standard Cells is made quicker because the UE does not need to perform a fresh EAP authentication round every time it moves from on AP to another. This means that there is a shorter interruption in the traffic flow when the UE moves between access points and thus less disruption is felt by applications relying on a continuous traffic stream.

A 3G CN can provide authentication and key management services to 3G+WLAN UEs in both air interfaces without requiring the deployment of a AAA Server infrastructure.

Thus, as options for authentication, it is possible to:
Use a WiFi one-time password derived from the keying mechanisms used for 3G SIM. This requires UE software modifications to access the SIM in this way but is totally invisible to the user
Generate a one-time password using a local AAA function within the 3G/WiFi small cell. This password could then be provided to the UE using any of the paths already laid out:
   OMA-DM delivers ANDSF file
   Smartphone App processing locally generated SMS (or SI Bs)
   User cut & paste of locally generated SMS
Send a fixed password delivered to the UE using the mechanisms described above.

The use of the local AAA could allow pure WiFi devices to connect if the standard WPA2 procedures were used.

As an alternative to providing an AAA server in the small cell access point, the AAA server could be provided in the cellular core network (for example in the HLR), and a part of the required functionality could be provided in the access point so that it can use the AAA server.

### Managed Operation of the WiFi Air Interfaces

Currently, in the absence of any other mechanism, the WiFi usage policy for a 3G/WiFi smartphone is set by the manufacturer and/or user of the device. However, having authenticated the UE, the access point can then also send commands as to how the usage policy of the WiFi air interface is fixed by the smartphone UE. For example, data sessions typically connect over WiFi in preference to 3G if the phone is connected to a WiFi AP in accordance with the connection manager configuration within the phone. (Which WiFi AP to connect to can be set by the ANDSF function in the operator network—or, far more commonly, by user intervention when a WiFi AP is detected.) It would be attractive to actively manage the WiFi connection in response to changing congestion/interference levels on both 3G and WiFi so that data throughput is maintained as best as possible under varying traffic loads. There are various ways in which this could be achieved:
At a very crude level, WiFi could be turned on of off dynamically by an SMS set to a smartphone App, or smartphone operating system connection manager function, which could enable or disable the WiFi connection. This requires no phone software modification but is clumsy means to route PS traffic either all by WiFi or all by 3G
A more sophisticated option would be a phone App, or smartphone operating system connection manager function, that could be instructed via messages over the WiFi link to throttle the data throughput on WiFi in response to overall throughput levels on both 3G and WiFi. This path would require some modification to the UE connection manager to introduce the throttling function to manage throughout which could then be controlled by the App. Of course, a minimum throughput would be maintained to allow the throttling messages to be received.
Building on the point above it is conceivable that a 3G data session is used to signal throttling/scheduling/management parameters dynamically to a specialised smartphone App, or smartphone operating system connection manager function, which could then control the throttling functions in the UE connection manager to manage the WiFi traffic in the most optimal way.
Some management functions could be traffic dependent. For example, with any necessary modifications to the connection manager and appropriate client software in the UE, video streams could be split between WiFi and 3G with “key frames” sent over 3G for lower latency/reliable delivery and other frames sent over WiFi.
   Integration of WiFi Traffic into Cellular Network

The co-location of WiFi and a sophisticated FAP software stack would allow WiFi traffic to be passed into the cellular core by packaging up the data traffic as a separate PDP context from other PS traffic flowing through the phone. Alternatively, the WiFi data might be sent as part of the same PDP context, using the same Iuh IPsec tunnel.

In general it might be expected that a cellular operator might seek to avoid sending additional traffic to a cellular core if it was possible to be offloaded directly onto the internet at the WiFi AP. However, filters or the like that have been set by the user for the cellular traffic can automatically be applied to the WiFi traffic, allowing operators to build customer value from managing all user traffic through a centralised core for enhanced security (that is, with a guarantee that a user identity could not be spoofed) or for guarantees on content (for example with access to adult sites restricted or prevented). This builds on the principle that the access point knows the identity of the user, because of the cellular connection, and can use this to provide services relating to the WiFi connection.

### Common Caching and URL Filtering, Virus Scanning Functions

The small cell access point includes a processing function to perform a number of functions that decouple the backhaul performance from the air interface performance. These functions include downlink caching of files/web pages that are accessed by multiple users, uplink caching of large files uploaded by users which can be fed up a congested backhaul link without burdening the air interface, compression functions that reduce the file sizes of large video, photo and audio files.

Any of these functions can be applied in common to traffic over either of the air interfaces in the access point.

The availability of this processing function in the access point means that it is also possible to include URL filters, to enforce operators' policies on accessible web sites, and to perform virus scanning of any files transferred. The use of common filters, policies, and the like allows freer integration of the WiFi data traffic into the cellular core network, and of data transferred over the cellular air interface into the IP network without passing through the cellular core network.

### Mobility/Grid Considerations

In the case of deployment of the type shown in FIG. 2 or FIG. 12, functions defined previously for an “Enterprise Grid” of femtocells can be extended to include the WiFi elements within the small cell. This would mean that:
Power level setting and WiFi channel selection could be coordinated within a group of cells using similar mechanisms to those already used for 3G
Any configuration problems can be resolved using information from the other access technology
For example, when a WiFi connection is marginal, the 3G air interface can be used to determine information about the pathloss and/or interference levels
If there is a coverage problem in the 3G network, this can be used to assist in the adaption of the WiFi configuration
Handover between WiFi and 3G elements might be coordinated so that as a user moves through the network with an active 3G call both 3G and WiFi links are “handed over”
In idle mode, roaming could be led by the WiFi connection, which will know that the UE is on a particular access point
Caches and WiFi AAA server database information could be coordinated and synchronised between nodes to provide overall resilience in the event of a unit failure and to allow secure, seamless roaming within a small cell grid for a WiFi connection.

The handover of connections will now be described in more detail.

Traditionally the deployment of new 3G cells would involve a high effort in terms of network planning in order to integrate those new cells with each other and into the existing (typically macro) network in a tightly coordinated fashion. Such a coordinated deployment of new 3G cells would involve the setting up of dedicated physical transport connections between the new cells themselves and towards the existing NW infrastructure, the manual configuration of new neighbour relations between the new cells and between the new cells and the existing macro cells, etc.

However, deployments of 3G cells that do not follow such a coordinated methodology are increasingly common. They rely on the widespread availability of cheap IP and/or LAN connectivity and on the ability of the new 3G cells to self-configure themselves and create the necessary logical and transport level associations between themselves and the existing 3G deployments.

Nevertheless such un-coordinated deployments of 3G cells suffer from several limitations by having to re-use the legacy 3G standards, arising from the inbuilt assumption in those standards of the use of a coordinated deployment procedure.

One of the most important of these limitations concerns the fact that before 3GPP Release 9 it was not possible to request a 3G UE to report the (unique) Logical Cell Identity of a measured 3G cell. This is because the 3G standards assumed that, as a result of the logical associations created during the coordinated deployment procedure, the UE reporting the Physical Cell Identity (PCI) (i.e. primary scrambling code PSC, and frequency carrier, UARFCN) operated by a 3G cell would always be enough for the NW to uniquely identify the reported cell.

3G standards also ‘force’ the UE to rely heavily on NW-provided detailed neighbour cells lists (where each neighbour cell is identified by its PCI) for mobility purposes, i.e., to a large extent if a cell's PCI is not provided as part of a neighbour list that cell will be ‘invisible’ to the UE for mobility purposes. At the same time the standards place strong restrictions on the number of entries that can be provided in a neighbour list.

The consequence is that operators typically can only spare a few entries/PCIs in their existing network neighbour lists to be used as pointers to the un-coordinated 3G cells and these 3G cells are thus forced to heavily re-use that small number of PCIs across their deployments.

This inexorably leads to difficulties in resolving the UE reported PCI of an un-coordinated 3G cell into that cell's unique Logical Cell ID, which is essential for supporting handover to that cell as the target cell needs to be prepared in anticipation for the UE arrival

The situation in WLAN networks operating according to IEEE Std 802.11-2007 is very different. The mobility framework in these networks follows the UE-controlled mobility principle, instead of the NW controlled/UE-assisted mobility principle used in 3G NWs. This means that, while in 3G NWs during the handover procedure it is the role of the NW to prepare the target 3G cell to receive the 3G UE, in WLAN NWs that role is played by the UE itself. A consequence of this is that during the WLAN mobility preparation procedures the WLAN UE will always need to address the target WLAN AP using that AP's unique address/logical identity which is its MAC address.

Thus unlike the 3G mobility case, in the course of a WLAN mobility preparation procedure it will always be clear what the unique identity of the target AP is.

When one considers a network of integrated 3G+WLAN cells/APs, whose 3G ‘personality’ is deployed in an un-coordinated fashion (as described above) it is clear that there is scope for the integrated APs to cooperate in using the WLAN mobility preparation procedure to guide the resolution of the identity of the target 3G cell for an associated 3G handover procedure. The following describes how this can be achieved.

A network of ‘smart’ dual mode APs takes advantage of the fact that each AP is simultaneously a 3G and WLAN ‘provider’, by having their 3G personalities use UE mobility-related information gathered via their WLAN personalities to prepare 3G handovers between themselves, which would otherwise be compromised by the source 3G AP's inability to uniquely identify the target 3G AP from UE 3G measurement reports alone.

### New Abbreviations

### IE: Information Element

### MS: Multi Standard

### SA: Security Association

### BSS: Base Station Service

In order to describe the invention we shall start by reviewing in detail what are the limitations in supporting 3G handover between 3G ‘cells’ deployed in a ‘un-coordinated’ fashion i.e. with no manual cell planning in the macro network or the cells themselves, etc. Then we shall review how mobility is handled in WLAN networks.

Finally we describe an embodiment of the invention that consists on how in the case of a deployment of dual mode 3G+WLAN APs/Cells, (where the 3G cell “personality’ of the AP is deployed in an un-coordinated fashion) the WLAN mobility procedure between two APs can assist in the ‘associated’ 3G handover procedure between two APs.

Consider the case of a 3 G operator which determines that it can only set aside four entries in its 3G macro cell's neighbour lists for the support of mobility towards un-coordinated 3G small cell deployments. Each entry in these lists corresponds to one Physical Cell ID (PCI). The reserved PCIs are denominated {PCI_{—}1, PCI_{—}2, PCI_{—}3, and PCI_{—}4}.

Consider then the case of an enterprise deployment of (contiguous) ‘small 3G cells’ which is not coordinated with the macro cellular network that surrounds/overlaps the enterprise and which is deployed without local manual cell planning. That is, the small cells self-configure their PCI, (logical) Cell ID etc.

Naturally, all small 3G cells must operate one of these four PCIs: {PCI_{—}1, PCI_{—}2, PCI_{—}3, and PCI_{—}4}.

In order to minimise the probability of a UE being exposed to transmissions from two different small cells using the same PCI, each small cell will be programmed to self-configure to use a PCI that is not being used by any of the other small cells it detects in its surroundings (roughly speaking its first order neighbours).

The small cells in the enterprise are assumed to be able to inter-communicate allowing them to exchange information relevant to each other's operations, e.g. the (Cell ID, PCI) pairs each small cell detects.

This and other information sharing procedures may go some way towards allowing each small cell to build a ‘map of the deployment’. However, there will always be cases where, when a small cell receives a UE measurement report for a certain PCI, it cannot resolve that PCI into the associated unique Cell Identity. This means that the standardised 3G handover methods cannot be used since they assume that the source RNC/BSC function knows the unique cell identity of the target cell so that it can address it to prepare it for the handover.

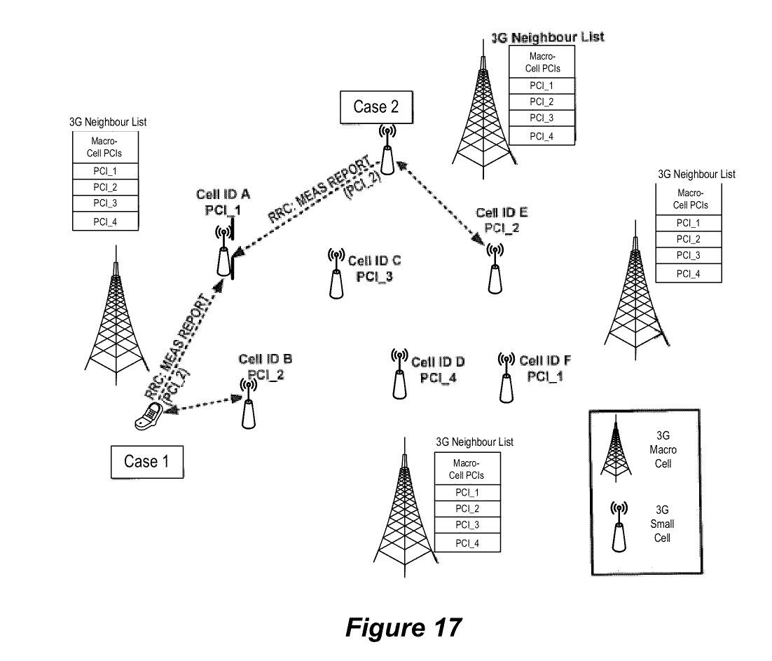

An example scenario is shown in FIG. 17 below, where Small Cell A cannot differentiate Case 1 from Case 2, i.e., cannot differentiate whether the UE is reporting Small Cell B or Small Cell E when it receives a RRC: MEASUREMENT REPORT quoting PCI_{—}2.

As such it does not know which small cell to prepare for the 3G handover.

In WLAN networks, contrary to the case of 3G networks, mobility is UE controlled, i.e., it is the UE (WLAN station), not the Network (i.e. the WLAN APs), that ultimately decides which WLAN AP the UE associates with.

Accordingly, unlike the case of 3G NWs, where the network is responsible for preparing the target 3G cell for the 3G handover procedure, in WLAN NWs it is up to the UE (WLAN Station) to prepare the target WLAN AP for the transition from being associated with the ‘source’ AP to being associated with the ‘target’ AP.

The current WLAN base standard, i.e., IEEE Std 802.11-2007 supports two BSS/AP transition methods:

(Note: A Base Station Service (BSS) is composed of a WLAN AP and the WLAN Stations that are associated with it.)

### In Case 1: BSS Transition Using Pre-Authentication (Support is Optional)

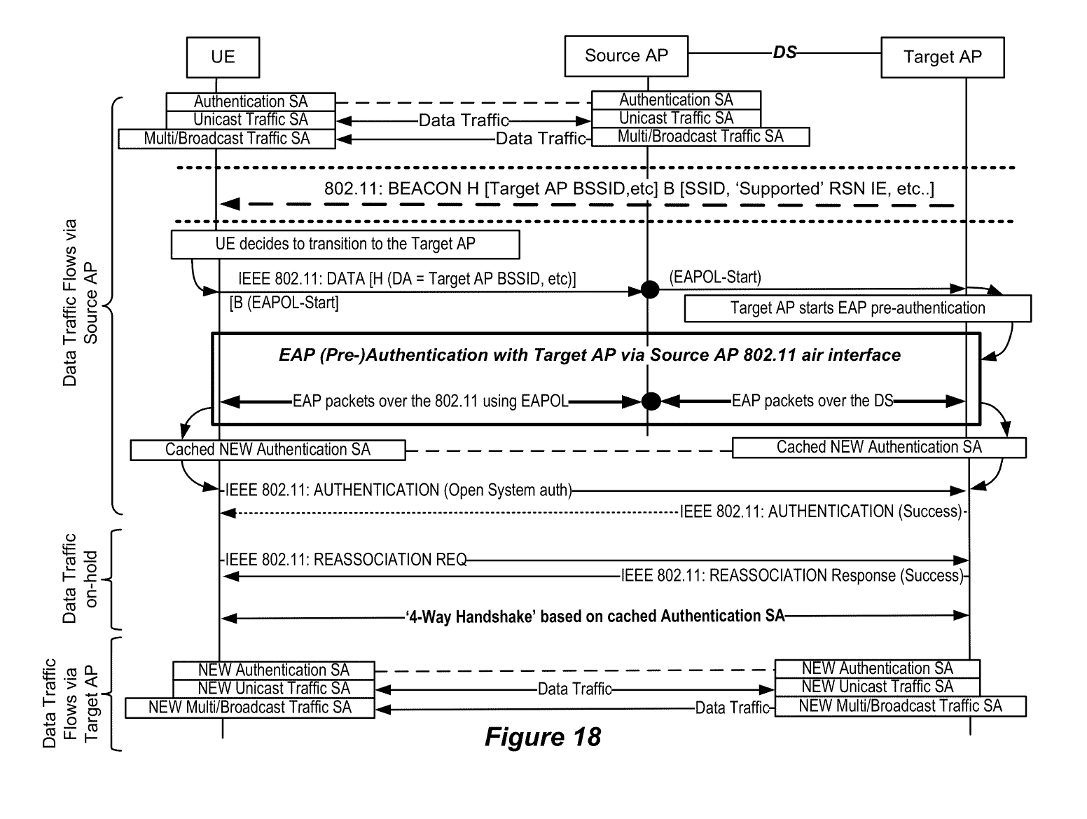

In this case, as shown in FIG. 18, the WLAN UE while associated with the source AP reads the BEACON frame broadcast by the target AP discovering the target AP's SSID, BSSID (=MAC address), security capabilities, data rate capabilities, etc. The WLAN UE then contacts the target AP via the source AP (Source AP and Target AP are connected via the Distribution Service, DS) in order to request the target AP to trigger a pre-authentication procedure so that, when it decides to associate with the target AP, there is no need to run IEEE 802.1X/EAP authentication again. This minimises the data connectivity interruption time. The WLAN UE communicates with the target AP by sending a DATA frame to the Source AP whose header contains the target AP BSSID/MAC address in the Destination Address field, and whose body contains an EAPOL-Start packet. The Source AP sends the EAPOL-Start packet towards the Target AP (MAC address) using the Distribution Service (DS). When the Target AP receives this packet it starts a new IEEE 802.1X/EAP authentication procedure towards the UE whose signalling will use the source AP as pass-through.

If pre-authentication is successful both the UE and the target AP will share a cached authentication SA.

Thus when the UE decides to reassociate with the Target AP it can skip the 802.1X/EAP authentication procedure and will only have to perform the ‘4-Way handshake procedure’ to setup the Security Associations to protect the data traffic. This reduces the amount of time the UE looses data connectivity during AP transition.

### Case 2: BSS Transition NOT Using Pre-Authentication

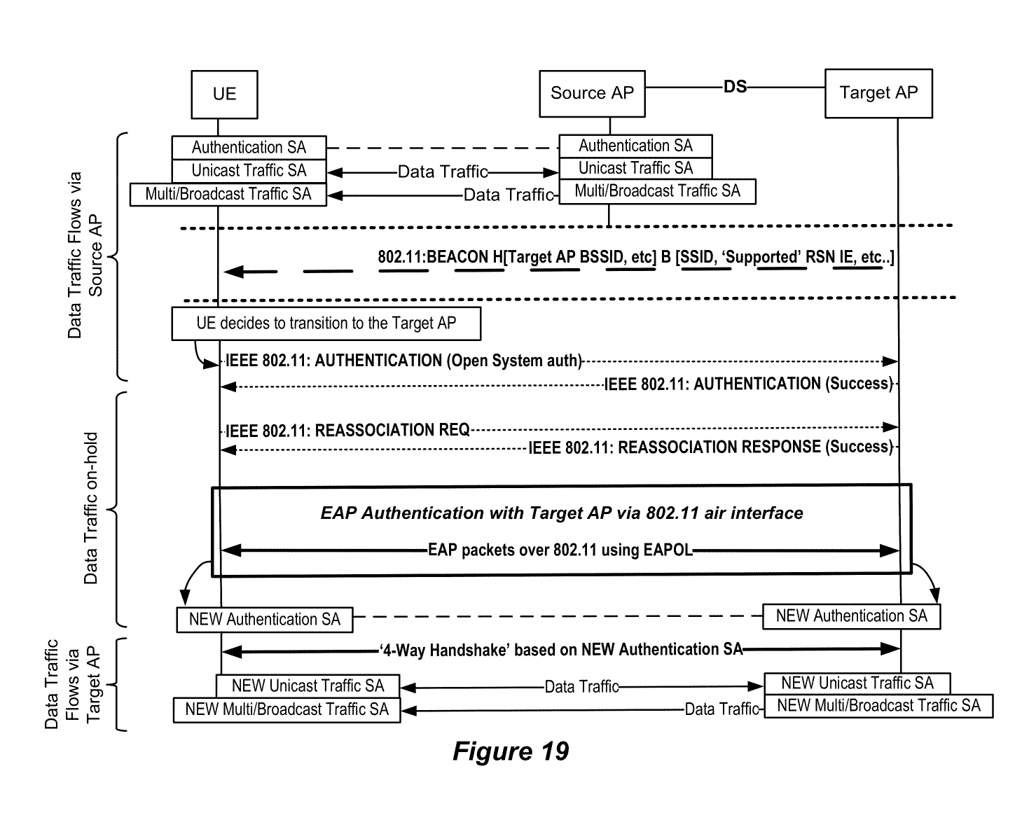

In this case, as shown in FIG. 19, the WLAN UE while associated with the source AP reads the BEACON frame broadcast by the target AP discovering the target AP's SSID, BSSID (=MAC address), security capabilities, data rate capabilities, etc. When it determines that it should associate with the target AP it will directly contact the target AP using the IEEE 802.11 air interface. When it requests to re-associate with the target AP it suspends sending/receiving data until the authentication and ‘4-Way handshake’ procedures (with the target AP) are completed.

The IEEE 802.11r-2008 ‘Fast BSS Transition’ (aka FT) amendment of IEEE Std 802.11-2007 introduces two new mechanisms by which a WLAN UE can create the necessary state in a Target AP (i.e. prepare the target AP) to receive it before the UE actually dissociates with the Source AP, that go beyond pre-authentication (i.e. the ‘pre-creation’ of an authentication context/SA between UE and Target AP) in order to further reduce the amount of time during which the UE has to suspend data traffic when moving between APs.

Both mechanisms allow not only the ‘pre-creation’ of an authentication context/SA between UE and Target AP, but also the ‘pre-creation’ of Security Associations between UE and Target AP to be used to protect the unicast and the multi/broadcast traffic and even make any necessary QoS reservations (when QoS Admission Control is supported in the NW).

### Case 3: Over-the Air Fast BSS Transition:

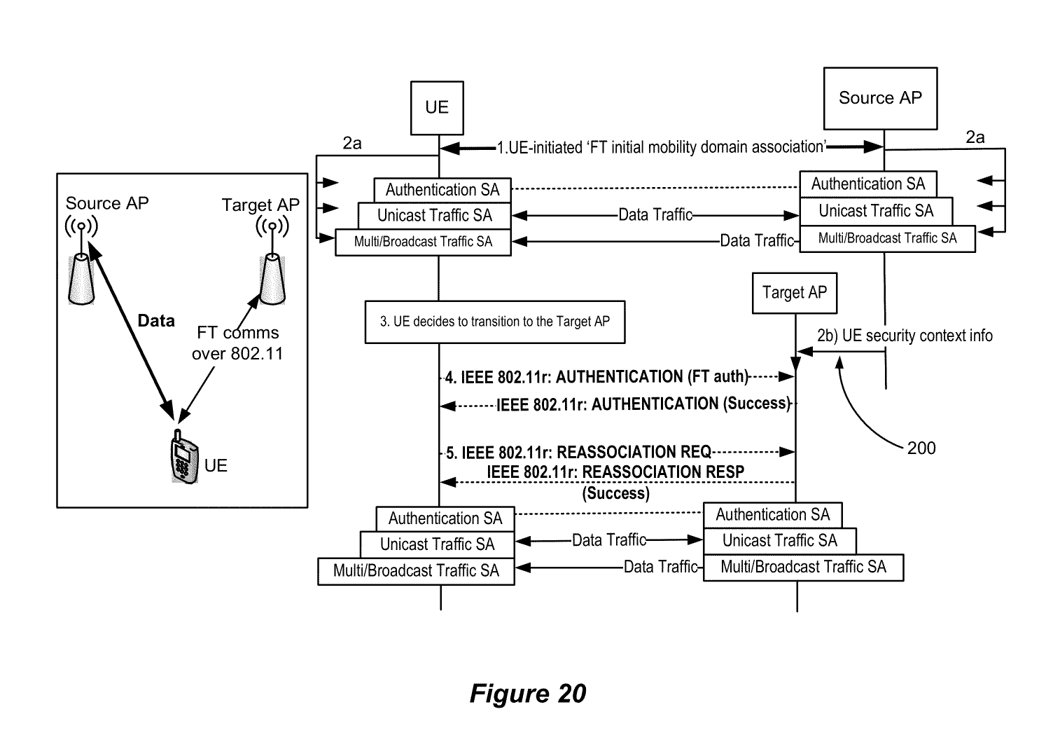

In this method, as shown in FIG. 20, in order to prepare the Target AP, the UE communicates with the Target AP (while associated with the Source AP) directly via the IEEE 802.11 air interface. The FT authentication and SA setup is based on shared secrets created during the initial association procedure and which the original/initial AP involved (securely) distributed to all other APs in the deployment (message 200 in FIG. 20).

### Case 4: Over-the-DS Fast BSS Transition:

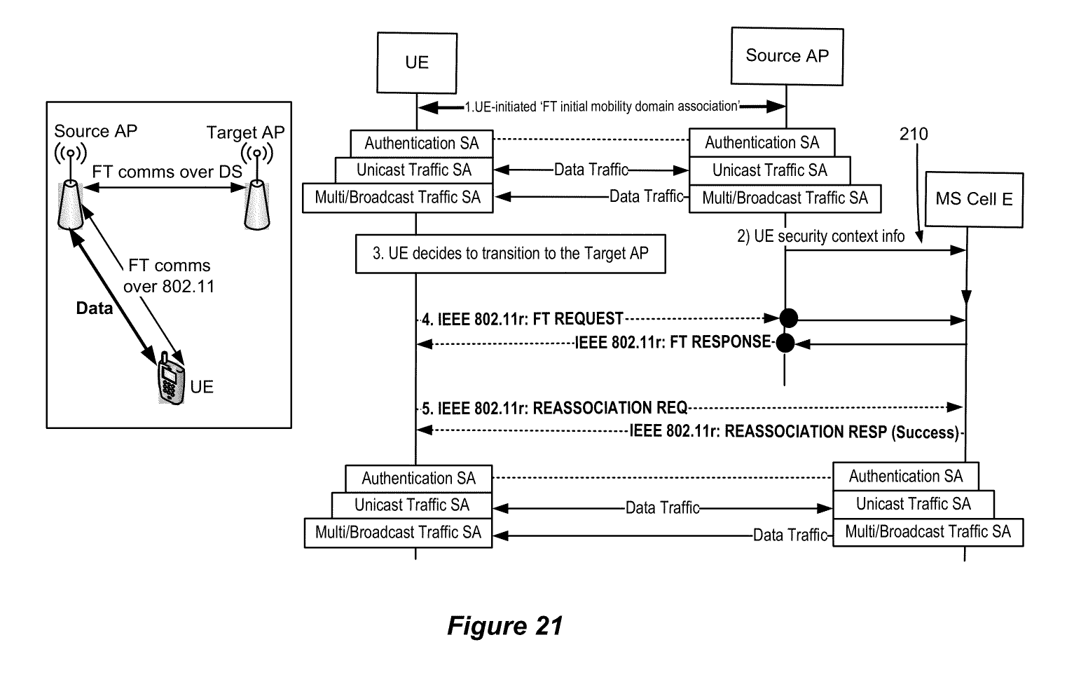

In this method, as shown in FIG. 21, in order to prepare the Target AP, the UE communicates with the target AP via the current AP relying on the Distribution Service (DS) to relay its communications between APs. (This is similar to the way pre-authentication is already defined in the IEEE 802.11-2007 standard, i.e. Case 1). The FT authentication and SA setup is based on shared secrets created during the initial association procedure and which the original/initial AP involved (securely) distributed to all other APs in the deployment (message 210 in FIG. 21).

Thus it can be seen that, either using the traditional BSS transition mechanisms of IEEE Std 802.11-2007 or using the Fast BSS Transition mechanisms of IEEE Std 802.11r-2008, there are two scenarios: 1) the UE uses over-the-air preparation of the Target AP and 2) the UE uses over-the DS preparation of the Target AP.

We now consider the scenario originally described in FIG. 17, but where now the enterprise 3G small cells are actually dual mode 3G+WLAN Multi Standard Cells, and examine how the UE WLAN mobility procedure between Multi Standard Cells can assist in the ‘associated’ UE 3G handover procedure between Multi Standard Cells.

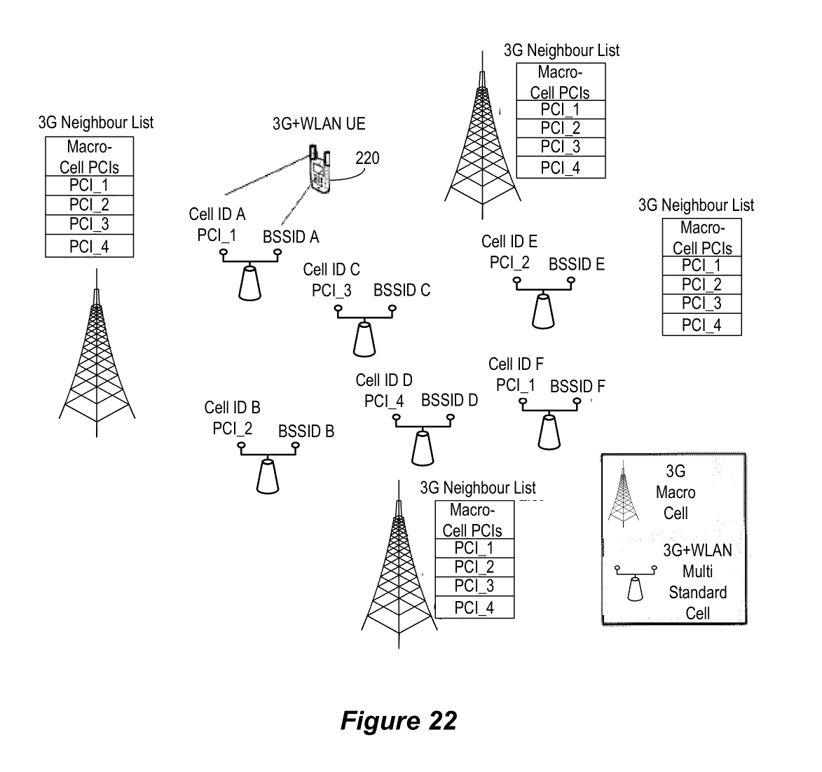

A relevant part of the network is illustrated in FIG. 22. Note that it is assumed that, as part of their Self-Organising Network (SON) procedures, each Multi Standard Cell has informed the other Cells of its 3G and WLAN logical identifiers, i.e. (3G Cell ID, WLAN BSSID/MAC Address).

Now consider a UE 220 that enters the enterprise deployment via Multi Standard Cell A and accesses its services via both its 3G and WLAN radios, where it is in RRC CELL_DCH state—see 3GPP TS 25.331—in the 3G domain and has the necessary security associations [see IEEE Std 802.11-2007] (and optionally QoS state) in the WLAN domain which allow it to receive/transmit MAC data frames at ‘any time’.

Furthermore assume that:
Multi Standard Cell A locally queried (using the MM/GMM Identification procedure defined in 3GPP TS 24.008) the UE over the 3G domain for its IMSI at the time it first provided 3G service to the UE
The UE included its IMSI as a vendor-specific IE in the IEEE 802.11: AUTHENTICATION frame it sent to Multi Standard Cell A during its initial association procedure

As a consequence, Multi Standard Cell A knows the binding between the UE's IMSI and MAC address.

If at some point the UE's WLAN personality decides (e.g. due to e.g. radio quality issues) that it should stop being associated with Multi Standard Cell A and instead become associated with Multi Standard Cell E then, as reviewed above, there are four possible ways in which the UE can go about preparing the target AP functionality of Multi Standard Cell E. Assuming that the UE is programmed to always include its IMSI as a vendor-specific IE in the first IEEE 802.11 Management frame it sends to the Target AP the four cases are described below:

### Case 1: BSS Transition Using Pre-Authentication

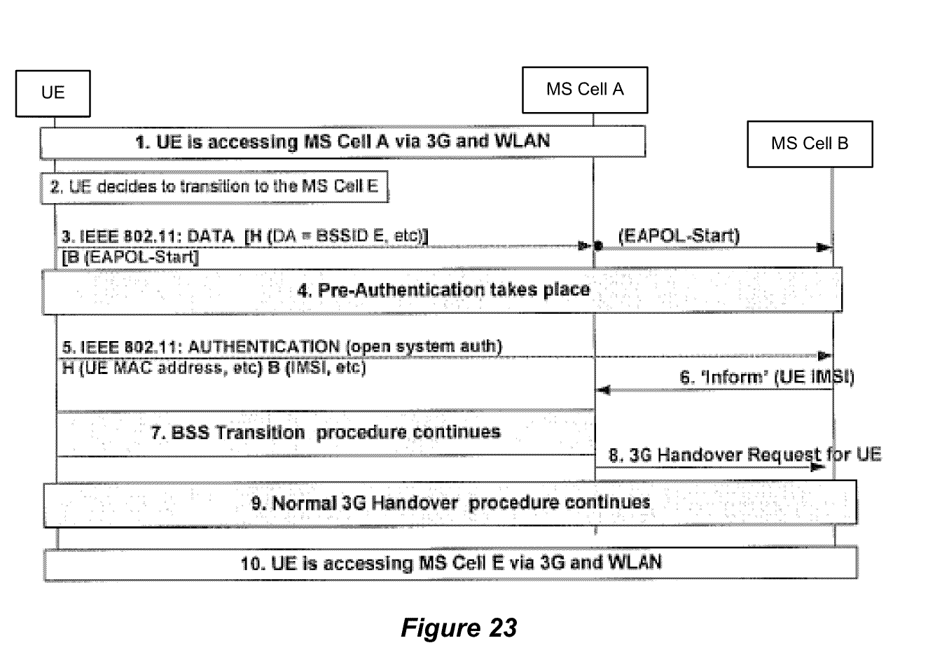

In this case, as shown in FIG. 23:
1. UE is accessing MS Cell A via both its 3G and WLAN radios, where it is in RRC CELL_DCH state in the 3G domain and has the necessary security associations in the WLAN domain which allow it to receive/transmit MAC data frames at any time
2. UE decides to transition to MS Cell E
3. UE sends a IEEE 802.11: DATA frame to MS Cell A quoting the BSSID/MAC Address of the MS Cell E and its own MAC Address in the Header and carrying an EAPOL-Start packet in its Body. MS Cell A uses the DS to send the EAPOL-Start packet to MS Cell E
   Note: MS Cell A may at this point ‘register’ that the UE is preparing MS Cell E for BSS transition and start the 3G handover preparation procedure to MS Cell E right away. Note: MS Cell A knows the binding between the UE's WLAN ID (MAC address) and ‘3G ID’ (IMSI) since the UE included its IMSI as a vendor specific IE in IEEE 802.11 signalling when it associated with the MS Cell A AP)
4. Pre-authentication between the UE and MS Cell E takes place via MS Cell A
5. UE directly sends MS Cell E an IEEE 802.11: AUTHENTICATION frame (for ‘open system authentication’) containing its MAC address in its header (as usual) and its IMSI in a vendor-specific IE in its body- to start the transition to MS Cell E

6. MS Cell E uses the communication framework that inter-connects the MS Cells in the deployment to inform MS Cell A that the UE is preparing its WLAN transition thus informing MS Cell A of the 3G cell identity of the target cell

7. Meanwhile the BSS transition (without new authentication) procedure continues
8. MS Cell A starts to prepare the 3G handover of the UE to MS cell E, if it has not already done so at step 3
9. The normal 3G handover procedure from MS Cell A to MS Cell E takes place
10. In the end the UE is accessing MS Cell E via both its 3G and WLAN radios, where it is in RRC CELL_DCH state in the 3G domain and has the necessary security associations in the WLAN domain which allow it to receive/transmit MAC data frames at any time.

### Case 2: BSS Transition NOT Using Pre-Authentication

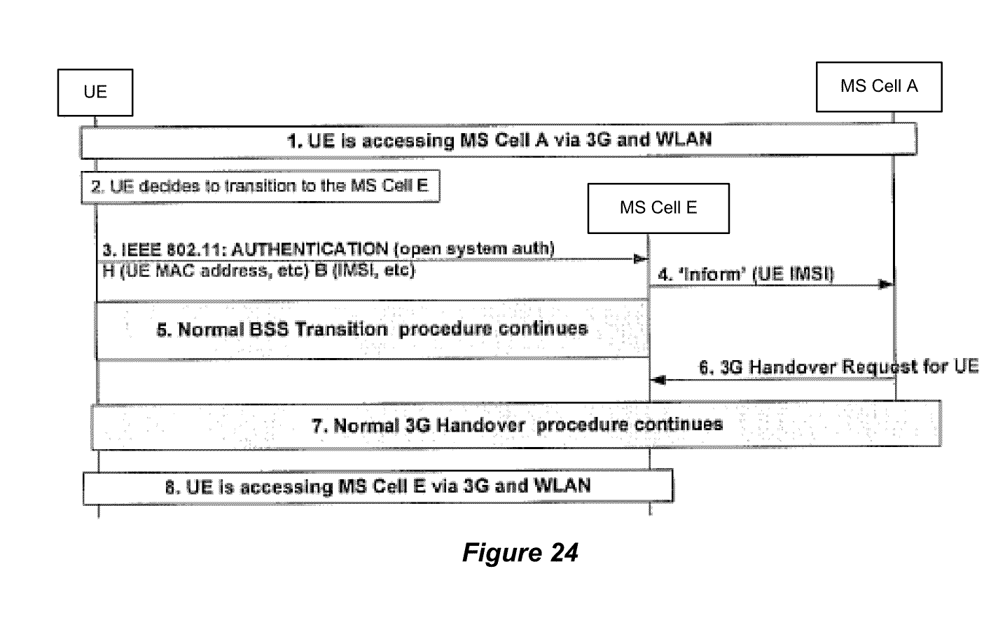

In this case, as shown in FIG. 24:
1. UE is accessing MS Cell A via both its 3G and WLAN radios, where it is in RRC CELL_DCH state in the 3G domain and has the necessary security associations in the WLAN domain which allow it to receive/transmit MAC data frames at any time
2. UE decides to transition to MS Cell E
3. UE sends MS Cell E an IEEE 802.11: AUTHENTICATION frame (for ‘open system authentication’) containing its MAC address in its header (as usual) and its IMSI in a vendor-specific IE in its body to start the transition to MS Cell E
4. MS Cell E uses the communication framework that inter-connects the MS Cells in the deployment to inform MS Cell A that the UE is preparing its WLAN transition thus informing MS Cell A of the 3G cell identity of the target cell
5. Meanwhile the Normal BSS transition procedure continues
6. MS Cell A starts to prepare the 3G handover of the UE to MS cell E
7. The normal 3G handover procedure from MS Cell A to MS Cell E takes place
8. In the end the UE is accessing MS Cell E via both its 3G and WLAN radios, where it is in RRC CELL_DCH state in the 3G domain and has the necessary security associations in the WLAN domain which allow it to receive/transmit MAC data frames at any time.

### Case 3: Over-the Air Fast BSS Transition

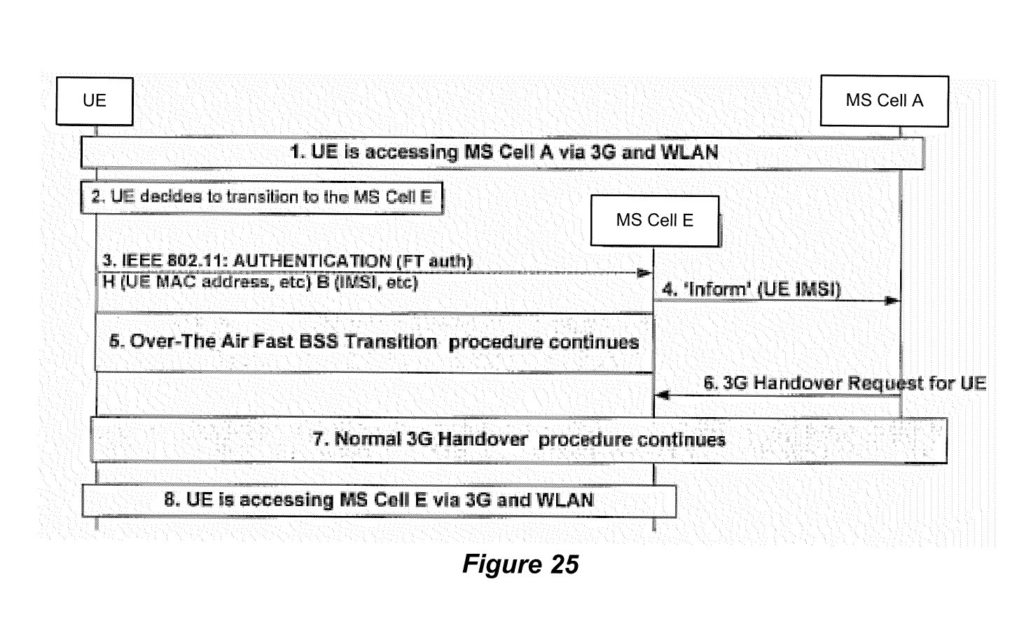

In this case, as shown in FIG. 25:
1. UE is accessing MS Cell A via both its 3G and WLAN radios, where it is in RRC CELL_DCH state in the 3G domain and has the necessary security associations in the WLAN domain which allow it to receive/transmit MAC data frames at any time
2. UE decides to transition to MS Cell E
3. UE sends MS Cell E an IEEE 802.11: AUTHENTICATION frame (for ‘FT authentication’) containing its MAC address in its header (as usual) and its IMSI in a vendor-specific IE in its body to start the transition to MS Cell E
4. MS Cell E uses the communication framework that inter-connects the MS Cells in the deployment to inform MS Cell A that the UE is preparing its WLAN transition thus informing MS Cell A of the 3G cell identity of the target cell
5. Meanwhile the Over-the-air Fast BSS transition procedure continues
6. MS Cell A starts to prepare the 3G handover of the UE to MS cell E
7. The normal 3G handover procedure from MS Cell A to MS Cell E takes place
8. In the end the UE is accessing MS Cell E via both its 3G and WLAN radios, where it is in RRC CELL_DCH state in the 3G domain and has the necessary security associations in the WLAN domain which allow it to receive/transmit MAC data frames at any time.

### Case 4: Over-the-DS Fast BSS Transition

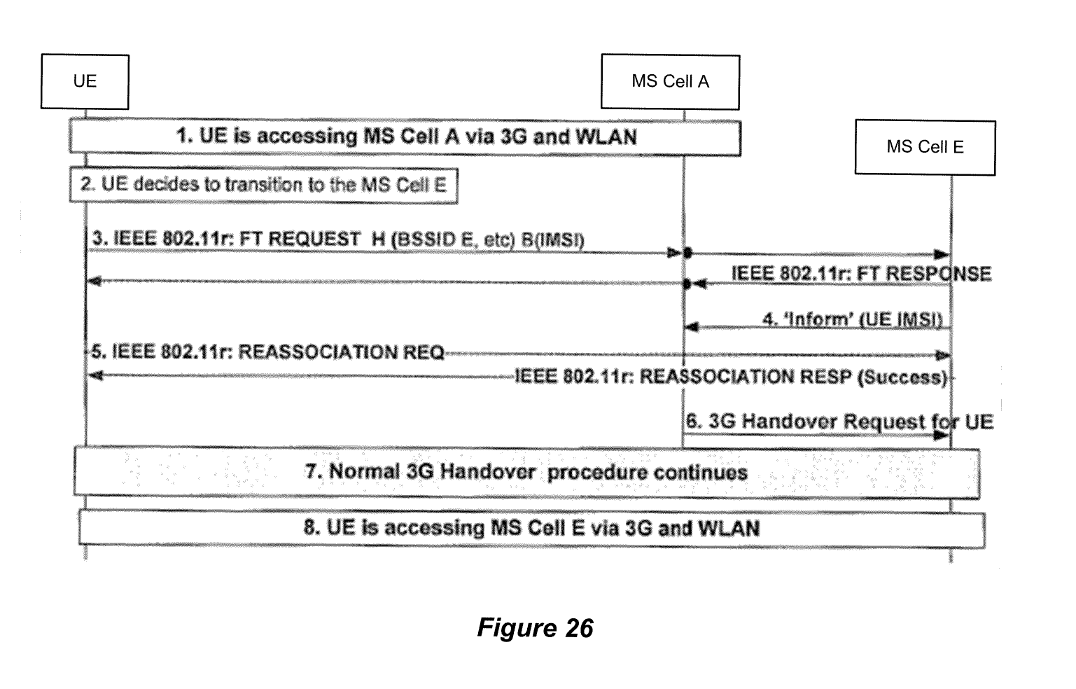

In this case, as shown in FIG. 26:
1. UE is accessing MS Cell A via both its 3G and WLAN radios, where it is in RRC CELL_DCH state in the 3G domain and has the necessary security associations in the WLAN domain which allow it to receive/transmit MAC data frames at any time
2. UE decides to transition to MS Cell E
3. UE sends an IEEE 802.11 r: FT REQUEST frame to MS Cell A quoting the BSSID/MAC Address of the MS Cell E in its Header and carrying the UE's IMSI as a vendor-specific IE in its body. MS Cell A uses the DS to send the frame to MS Cell E
4. MS Cell E uses the communication framework that inter-connects the MS Cells in the deployment to inform MS Cell A that the UE is preparing its WLAN transition thus informing MS Cell A of the 3G cell identity of the target cell
5. Meanwhile the Fast BSS transition procedure is completed
6. MS Cell A starts to prepare the 3G handover of the UE to MS cell E
7. The normal 3G handover procedure from MS Cell A to MS Cell E takes place
8. In the end the UE is accessing MS Cell E via both its 3G and WLAN radios, where it is in RRC CELL_DCH state in the 3G domain and has the necessary security associations in the WLAN domain which allow it to receive/transmit MAC data frames at any time.

Thus, there is no need for the operator to deploy complex proprietary solutions or be restricted to 3GPP Release 9 UEs (not available) to identify the target 3G cell in order to support 3G handover between dual mode Access Points in non-radio planned deployments of such APs, e.g. enterprise-like deployments.

There is therefore disclosed an access point that allows efficient use of the available radio spectrum, in order to improve a user experience, while limiting additional costs for the operator.

What is claimed is:

1. A method of authenticating a user equipment device in a WiFi access point, wherein the user equipment device is adapted to operate in a cellular network and in a WiFi communications link, and wherein the WiFi access point is co-located with a base station of the cellular network,
the method comprising:
after receiving from the user equipment device a request for access to the cellular network, generating keys for authenticating the user equipment device in the cellular network; and
using said keys to authenticate the user equipment device for the WiFi communications link with the WiFi access point.

2. A method as claimed in claim 1, wherein the keys are one-time keys.

3. A method as claimed in claim 1, wherein the keys are fixed keys.

4. A method as claimed in claim 1, 2 or 3, comprising sharing the keys with at least one other access point, such that the user equipment device can be authenticated for a WiFi communications link with the other WiFi access point.

5. A method of identifying a WiFi access point, comprising:
determining an ID for the WiFi access point, and
notifying user equipment devices of the ID over a cellular air interface.

6. A method as claimed in claim 5, comprising determining the ID by using a mini-OMA-DM server in the access point itself.

7. A method as claimed in claim 5 or 6, comprising selecting the ID based on detected identifiers of nearby access points.

8. A method as claimed in claim 5 or 6, comprising selecting a WiFi frequency for the WiFi access point based on frequencies of detected nearby access points.

9. A method as claimed in claim 5 or 6, comprising selecting a power for the WiFi access point based on signals detected from nearby access points.

10. A method as claimed in claim 5 or 6, comprising notifying user equipment devices of the ID by an SMS originated in the access point.

11. A method as claimed in claim 10, wherein the SMS is to be read, and the ID manually applied by a user of the user equipment device.

12. A method as claimed in claim 10, wherein the SMS is to be automatically interpreted by the user equipment device.

13. A method as claimed in claim 5 or 6, comprising notifying user equipment devices of the ID by information in a System Information Block transmitted on a cellular broadcast channel.

14. A method of transferring data between a user equipment device and an access point, having WiFi and cellular air interface connections, the method comprising:
transferring one part of the data over the WiFi interface and another part of the data over the cellular air interface.

15. A method as claimed in claim 14, comprising splitting the traffic so that data from one application is transferred over the WiFi interface and data from another application is transferred over the cellular air interface.

16. A method as claimed in claim 14, comprising splitting the traffic so that one part of the data from an application is transferred over the WiFi interface and another part of the data from the same application is transferred over the cellular air interface.

17. A method as claimed in claim 16, comprising splitting video traffic so that a key part of the video data is transferred over the cellular interface and another part of the data from the same application is transferred over the WiFi air interface.

18. A method of transferring data between a UE and an access point, having WiFi and cellular air interface connections, the method comprising:
the access point sending control messages to the UE to control the amount of data sent by the UE over the WiFi interface.

19. A method as claimed in claim 18, wherein the control message causes the WiFi connection to be turned off.

20. A method as claimed in claim 18, wherein the control message causes the WiFi connection data rate to be limited

21. A method as claimed in one of claims 18 to 20, comprising sending the control message by SMS.

22. A method as claimed in one of claims 18 to 20, comprising sending the control message in a cellular data session.

23. A method as claimed in one of claims 18 to 20, comprising sending the control message over the WiFi air interface.

24. A method of managing data traffic in an access point, having WiFi and cellular air interface connections, the method comprising:
establishing a path for data between a user equipment device and a cellular core network through the access point, wherein the data is transmitted between the user equipment device and the access point over the WiFi air interface, and the data is transmitted between the access point and the cellular core network in accordance with a cellular protocol.

25. A method as claimed in claim 24, wherein data received in the access point from the cellular core network, and intended for the user equipment device, is transmitted to the user equipment device over the WiFi air interface.

26. A method as claimed in claim 25, wherein the data is transmitted to the user equipment device over the WiFi air interface, subject to security and/or content guarantees established for that user equipment device in the cellular network.

27. A method as claimed in claim 24, wherein the cellular protocol is the Iuh protocol.

28. A method of handing over a cellular connection between a user equipment device and a first access point to a second access point, where each of the first and second access points has WiFi and cellular functionality, such that it is able to establish WiFi and cellular air interface connections, the method comprising:
determining an identity of the second access point in the cellular network, by using information that uniquely identifies the WiFi functionality of the second access point.

29. A method of handing over a cellular connection between a user equipment device and a first access point to a second access point, where each of the first and second access points has WiFi and cellular functionality, such that it is able to establish WiFi and cellular air interface connections, the method comprising,
in the user equipment:
determining that a handover from the first access point to the second access point is required; and
initiating a handover of a WiFi connection between the user equipment device and the first access point to the second access point; and
in the second access point:
notifying the first access point that the user equipment is initiating a handover thereto.

30. A method as claimed in claim 29, wherein the second access point notifies the first access point that the user equipment is initiating a handover thereto, uniquely identifying the user equipment device.

31. A method as claimed in claim 30, wherein the second access point uniquely identifies the user equipment device by means of its IMSI.

32. A method as claimed in one of claims 29-31, wherein the second access point communicates with the first access point over a LAN or an IP connection.
